(19) United States
(12) Patent Application Publication
(10) Pub. No.: US 2026/0032283 A1
(43) Pub. Date: Jan. 29, 2026

(54) END-TO-END LEARNING-BASED DYNAMIC POINT CLOUD CODING FRAMEWORK

(71) Applicant: InterDigital VC Holdings, Inc., Wilmington, DE (US)

(72) Inventors: Jiahao Pang, Plainsboro, NJ (US); Muhammad Asad Lodhi, Highland Park, NJ (US); Junghyun Ahn, New York, NY (US); Dong Tian, Boxborough, MA (US)

(21) Appl. No.: 18/784,466

(22) Filed: Jul. 25, 2024

(51) Int. Cl. H04N 19/597; G06V 10/44; H04N 19/137; H04N 19/51

(52) U.S. Cl. CPC H04N 19/597; G06V 10/44; H04N 19/137; H04N 19/51

(57) ABSTRACT

Some embodiments of a method may include: decoding a motion feature by accessing a motion bitstream; predicting a predicted feature based on the motion feature and one or more reference point cloud frames; decoding a first feature representing an occupancy status of a child level voxel; predicting a second feature based on the first feature and the predicted feature; and decoding a tree voxel occupancy status of the child level voxel via the second feature.

### INCORPORATION BY REFERENCE

The present application incorporates by reference in their entirety the following applications: U.S. patent application Ser. No. 18/679,144, entitled “AN END-TO-END LEARNING-BASED POINT CLOUD CODING FRAMEWORK” and filed May 30, 2024 (“144 application”); U.S. Provisional Patent Application Ser. No. 63/558,677, entitled “DYNAMIC DEEP OCTREE CODING FOR POINT CLOUD COMPRESSION” and filed Feb. 28, 2024 (“677 application”); U.S. Provisional Patent Application Ser. No. 63/543,479, entitled “EXPLICIT PREDICTIVE CODING FOR POINT CLOUD COMPRESSION” and filed Oct. 10, 2023 (“479 application”); and U.S. Provisional Patent Application Ser. No. 63/543,484, entitled “IMPLICIT PREDICTIVE CODING FOR POINT CLOUD COMPRESSION” and filed Oct. 10, 2023 (“484 application”).

### BACKGROUND

The present application is related to the field of point cloud compression and processing. This field aims to develop tools for compression, analysis, interpolation, representation and understanding of point cloud signals.

### SUMMARY

A first example method in accordance with some embodiments may include: decoding a motion feature by accessing a motion bitstream; predicting a predicted feature based on the motion feature and one or more reference point cloud frames; decoding a first feature representing an occupancy status of a child level voxel; predicting a second feature based on the first feature and the predicted feature; and decoding a tree voxel occupancy status of the child level voxel via the second feature.

For some embodiments of the first example method, decoding the motion feature includes: obtaining the motion bitstream; and passing the motion bitstream through a feature decoding process to obtain the motion feature.

For some embodiments of the first example method, the feature decoding process includes using an input derived from the one or more reference point cloud frames.

For some embodiments of the first example method, the input is derived from the one or more reference point cloud frames by performing a parameter estimation process on a reconstructed motion feature.

For some embodiments of the first example method, the reconstructed motion feature is derived from the one or more reference point cloud frames and the motion bitstream.

For some embodiments of the first example method, predicting the second feature includes passing the first feature and the predicted feature through a conditional decoder.

For some embodiments of the first example method, predicting the predicted feature includes: obtaining the one or more reference point cloud frames; and performing a predictor generation process based on the motion feature and the one or more reference point cloud frames to generate the predicted feature.

For some embodiments of the first example method, decoding the tree voxel occupancy status of the child level voxels includes: estimating occupancy probabilities using the second feature; accessing an occupancy bitstream; and performing arithmetic decoding of the occupancy bitstream via the estimated occupancy probabilities.

A first example apparatus in accordance with some embodiments may include: a processor; and a memory storing instructions operative, when executed by the processor, to cause the apparatus to: decode a motion feature by accessing a motion bitstream; predict a predicted feature based on the motion feature and one or more reference point cloud frames; decode a first feature representing an occupancy status of a child level voxel; predict a second feature based on the first feature and the predicted feature; and decode a tree voxel occupancy status of the child level voxel via the second feature.

A second example method in accordance with some embodiments may include: determining a motion feature from a current point cloud and one or more reference point cloud frames; predicting a predicted feature based on the motion feature; encoding the motion feature into a bitstream; determining a first feature representing an occupancy status of a child level voxel; determining a second feature based on the first feature and the predicted feature; and encoding the occupancy status of the child level voxel by encoding the second feature into the bitstream.

For some embodiments of the second example method, determining the motion feature includes: extracting a current feature from the current point cloud; and performing a motion estimation process on the extracted current feature and at least one of the one or more reference point cloud frames.

For some embodiments of the second example method, encoding the occupancy status of the child voxels includes: determining a third feature based on the second feature and the predicted feature; determining occupancy probabilities of the child voxels to be encoded; and encoding the occupancy status of the child voxels with the occupancy probabilities in an occupancy bitstream using an arithmetic encoder.

For some embodiments of the second example method, encoding the motion feature into the bitstream includes performing a feature encoding process on the motion feature using one or more estimated parameters.

For some embodiments of the second example method, the one or more estimated parameters includes at least one of a mean and a variance of previous reconstructed motion features.

For some embodiments of the second example method, predicting the predicted feature includes using a hyperprior encoder.

For some embodiments of the second example method, predicting the predicted feature includes: obtaining the motion feature from the bitstream; and passing the motion feature through a feature decoding process to obtain a first reconstructed motion feature.

For some embodiments of the second example method, the feature decoding process includes using an input derived from the one or more reference point cloud frames.

For some embodiments of the second example method, the input is derived from the one or more reference point cloud frames by performing a parameter estimation process on a second reconstructed motion feature.

For some embodiments of the second example method, at least one of the first reconstructed motion feature and the second reconstructed motion feature is derived based on the one or more reference point cloud frames.

A second example apparatus in accordance with some embodiments may include: a processor; and a memory storing instructions operative, when executed by the processor, to cause the apparatus to: determine a motion feature from a current point cloud and one or more reference point cloud frames; predict a predicted feature based on the motion feature; encode the motion feature into a bitstream; determine a first feature representing an occupancy status of a child level voxel; determine a second feature based on the first feature and the predicted feature; and encoding the occupancy status of the child level voxel by encoding the second feature into the bitstream.

### BRIEF DESCRIPTION OF THE DRAWINGS

The following detailed description will be better understood when read in conjunction with the appended drawings, in which there are shown examples of one or more of the multiple embodiments of the present disclosure. It should be understood, however, that the embodiments described herein are not limited to the precise arrangements and instrumentalities shown in the drawings. In the drawings:

FIG. 1A is a system diagram illustrating an example set of interfaces for a system according to some embodiments.

FIG. 1B is a schematic side view illustrating an example waveguide display that may be used with extended reality (XR) applications according to some embodiments.

FIG. 1C is a schematic side view illustrating an example alternative display type that may be used with extended reality applications according to some embodiments.

FIG. 1D is a schematic side view illustrating an example alternative display type that may be used with extended reality applications according to some embodiments.

FIG. 2 is a process diagram illustrating an example octree encoding process according to some embodiments.

FIG. 3 is a process diagram illustrating an example octree decoding process according to some embodiments.

FIG. 4 is a process diagram illustrating an example feature coding process for point cloud coding based on finer-level features according to some embodiments.

FIG. 5 is a process diagram illustrating an example octree coding process for point cloud coding based on finer-level features according to some embodiments.

FIG. 6 is a process diagram illustrating an example feature aggregator with only one level as an input according to some embodiments.

FIG. 7 is a process diagram illustrating an example feature aggregator with an aggregated feature as an input according to some embodiments.

FIG. 8 is a process diagram illustrating an example feature encoder using uniform quantization according to some embodiments.

FIG. 9 is a process diagram illustrating an example feature encoder using a hyperprior encoder according to some embodiments.

FIG. 10 is a process diagram illustrating an example occupancy probability estimator according to some embodiments.

FIG. 11 is a process diagram illustrating an example feature decoder according to some embodiments.

FIG. 12 is a process diagram illustrating an example feature decoder using a hyperprior decoder according to some embodiments.

FIG. 13 is a process diagram illustrating an example octree encoding according to some embodiments.

FIG. 14 is a process diagram illustrating an example octree decoding according to some embodiments.

FIG. 15 is a process diagram illustrating an example conditional encoder according to some embodiments.

FIG. 16 is a process diagram illustrating an example conditional decoder according to some embodiments.

FIG. 17 is a process diagram illustrating an example hierarchical inter-coding branch of an encoder according to some embodiments.

FIG. 18 is a process diagram illustrating an example hierarchical inter-coding branch of a decoder according to some embodiments.

FIG. 19 is a process diagram illustrating an example main hierarchical feature coding branch using a predicted feature according to some embodiments.

FIG. 20 is a process diagram illustrating an example main octree coding branch using predicted features according to some embodiments.

FIG. 21 is a process diagram illustrating an example motion estimator according to some embodiments.

FIG. 22 is a process diagram illustrating an example predictor generator according to some embodiments.

FIG. 23 is a process diagram illustrating an example main feature coding branch using predicted features according to some embodiments.

FIG. 24 is a process diagram illustrating an example lossy motion estimator according to some embodiments.

FIG. 25 is a process diagram illustrating an example lossy conditional encoder according to some embodiments.

FIG. 26 is a process diagram illustrating an example motion estimator using multiple resolutions according to some embodiments.

FIG. 27 is a flowchart illustrating an example decoding process according to some embodiments.

FIG. 28 is a flowchart illustrating an example encoding process according to some embodiments.

The entities, connections, arrangements, and the like that are depicted in—and described in connection with—the various figures are presented by way of example and not by way of limitation. As such, any and all statements or other indications as to what a particular figure “depicts,” what a particular element or entity in a particular figure “is” or “has,” and any and all similar statements—that may in isolation and out of context be read as absolute and therefore limiting—may only properly be read as being constructively preceded by a clause such as “In at least one embodiment, . . . ” For brevity and clarity of presentation, this implied leading clause is not repeated ad nauseum in the detailed description.

### DETAILED DESCRIPTION

In describing the various embodiments of the present disclosure, certain terminology is used herein for convenience only and should not be considered as limiting such embodiments. In the drawings, the same reference numerals are employed for designating the same elements throughout the several figures and the present description.

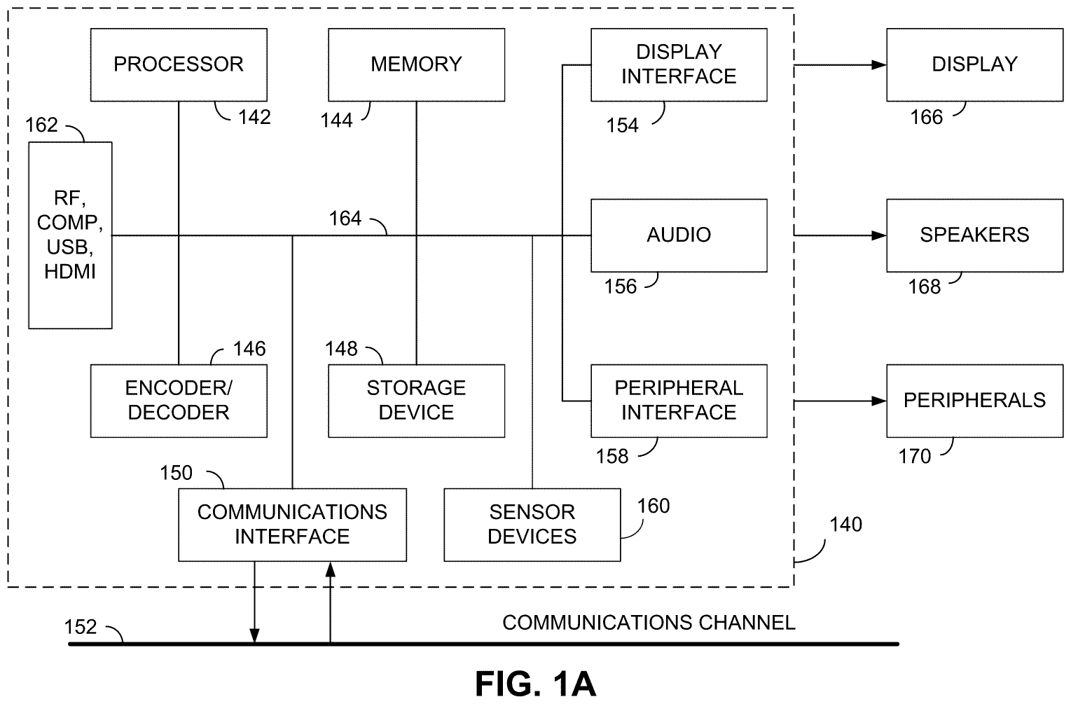

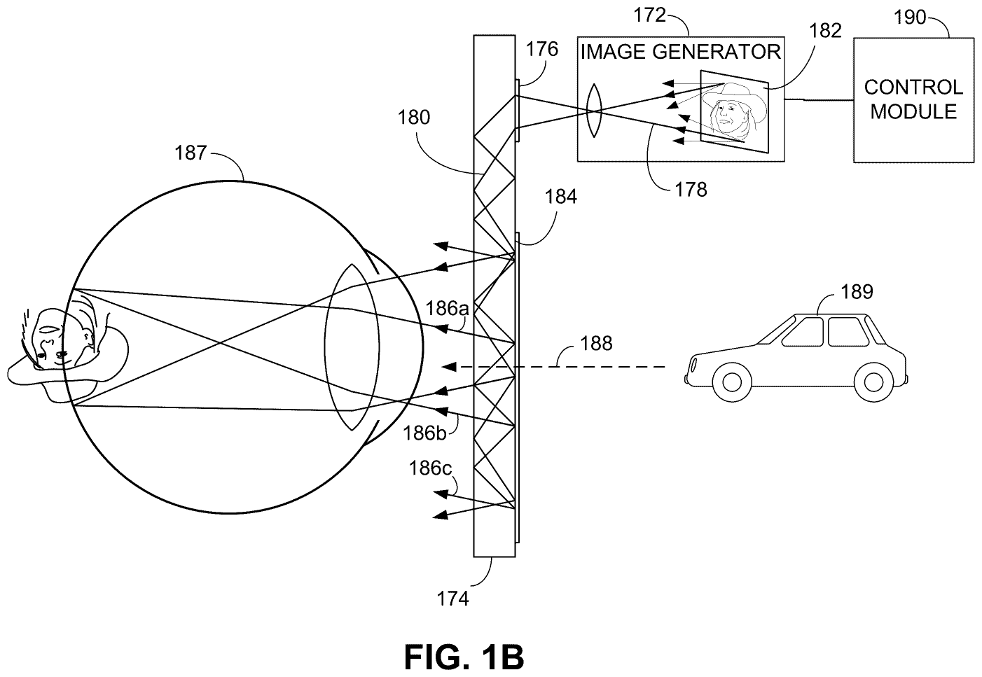

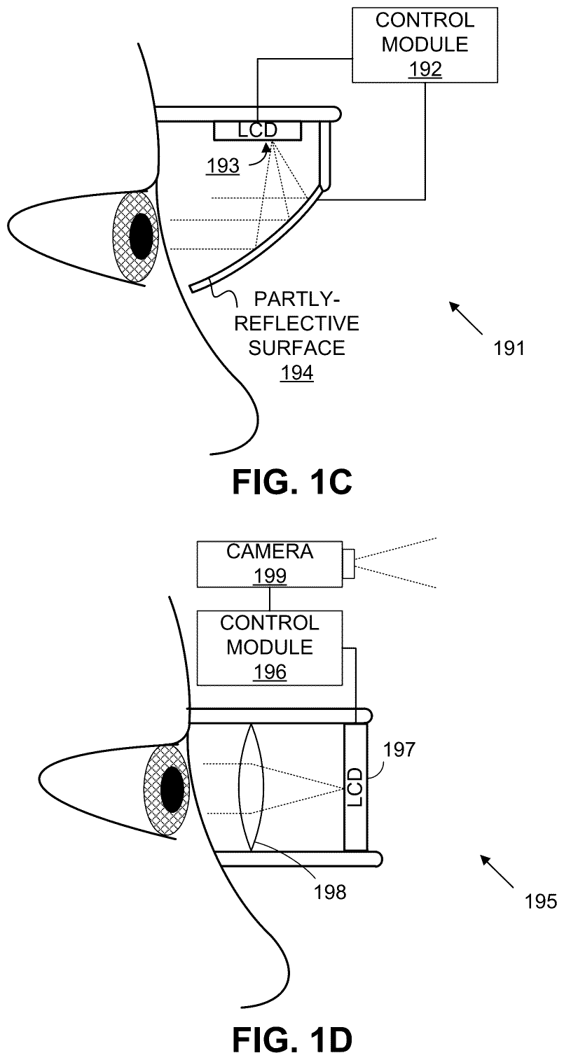

FIG. 1A is a system diagram illustrating an example set of interfaces for a system according to some embodiments. An extended reality display device, together with its control electronics, may be implemented using a system such as the system of FIG. 1A. System 140 can be embodied as a device including the various components described below and is configured to perform one or more of the aspects described in this document. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 140, singly or in combination, can be embodied in a single integrated circuit (IC), multiple ICs, and/or discrete components. For example, in at least one embodiment, the processing and encoder/decoder elements of system 140 are distributed across multiple ICs and/or discrete components. In various embodiments, the system 140 is communicatively coupled to one or more other systems, or other electronic devices, via, for example, a communications bus or through dedicated input and/or output ports. In various embodiments, the system 140 is configured to implement one or more of the aspects described in this document.

The system 140 includes at least one processor 142 configured to execute instructions loaded therein for implementing, for example, the various aspects described in this document. Processor 142 may include embedded memory, input output interface, and various other circuitries as known in the art. The system 140 includes at least one memory 144 (e.g., a volatile memory device, and/or a non-volatile memory device). System 140 may include a storage device 148, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive. The storage device 148 can include an internal storage device, an attached storage device (including detachable and non-detachable storage devices), and/or a network accessible storage device, as non-limiting examples.

System 140 includes an encoder/decoder module 146 configured, for example, to process data to provide an encoded video or decoded video, and the encoder/decoder module 146 can include its own processor and memory. The encoder/decoder module 146 represents module(s) that can be included in a device to perform the encoding and/or decoding functions. As is known, a device can include one or both of the encoding and decoding modules. Additionally, encoder/decoder module 146 can be implemented as a separate element of system 140 or can be incorporated within processor 142 as a combination of hardware and software as known to those skilled in the art.

Program code to be loaded onto processor 142 or encoder/decoder 146 to perform the various aspects described in this document can be stored in storage device 148 and subsequently loaded onto memory 144 for execution by processor 142. In accordance with various embodiments, one or more of processor 142, memory 144, storage device 148, and encoder/decoder module 146 can store one or more of various items during the performance of the processes described in this document. Such stored items can include, but are not limited to, the input video, the decoded video or portions of the decoded video, the bitstream, matrices, variables, and intermediate or final results from the processing of equations, formulas, operations, and operational logic.

In some embodiments, memory inside of the processor 142 and/or the encoder/decoder module 146 is used to store instructions and to provide working memory for processing that is needed during encoding or decoding. In other embodiments, however, a memory external to the processing device (for example, the processing device can be either the processor 142 or the encoder/decoder module 142) is used for one or more of these functions. The external memory can be the memory 144 and/or the storage device 148, for example, a dynamic volatile memory and/or a non-volatile flash memory. In several embodiments, an external non-volatile flash memory is used to store the operating system of, for example, a television. In at least one embodiment, a fast external dynamic volatile memory such as a RAM is used as working memory for video coding and decoding operations, such as for MPEG-2 (MPEG refers to the Moving Picture Experts Group, MPEG-2 is also referred to as ISO/IEC 13818, and 13818-1 is also known as H.222, and 13818-2 is also known as H.262), HEVC (HEVC refers to High Efficiency Video Coding, also known as H.265 and MPEG-H Part 2), or VVC (Versatile Video Coding, a new standard being developed by JVET, the Joint Video Experts Team).

The input to the elements of system 140 can be provided through various input devices as indicated in block 162. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 1A, include composite video.

In various embodiments, the input devices of block 162 have associated respective input processing elements as known in the art. For example, the RF portion can be associated with elements suitable for (i) selecting a desired frequency (also referred to as selecting a signal, or band-limiting a signal to a band of frequencies), (ii) downconverting the selected signal, (iii) band-limiting again to a narrower band of frequencies to select (for example) a signal frequency band which can be referred to as a channel in certain embodiments, (iv) demodulating the downconverted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, downconverting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, downconverting, and filtering again to a desired frequency band. Various embodiments rearrange the order of the above-described (and other) elements, remove some of these elements, and/or add other elements performing similar or different functions. Adding elements can include inserting elements in between existing elements, such as, for example, inserting amplifiers and an analog-to-digital converter. In various embodiments, the RF portion includes an antenna.

Additionally, the USB and/or HDMI terminals can include respective interface processors for connecting system 140 to other electronic devices across USB and/or HDMI connections. It is to be understood that various aspects of input processing, for example, Reed-Solomon error correction, can be implemented, for example, within a separate input processing IC or within processor 142 as necessary. Similarly, aspects of USB or HDMI interface processing can be implemented within separate interface ICs or within processor 142 as necessary. The demodulated, error corrected, and demultiplexed stream is provided to various processing elements, including, for example, processor 142, and encoder/decoder 146 operating in combination with the memory and storage elements to process the datastream as necessary for presentation on an output device.

Various elements of system 140 can be provided within an integrated housing, Within the integrated housing, the various elements can be interconnected and transmit data therebetween using suitable connection arrangement 164, for example, an internal bus as known in the art, including the Inter-IC (12C) bus, wiring, and printed circuit boards.

The system 140 includes communication interface 150 that enables communication with other devices via communication channel 152. The communication interface 150 can include, but is not limited to, a transceiver configured to transmit and to receive data over communication channel 152. The communication interface 150 can include, but is not limited to, a modem or network card and the communication channel 152 can be implemented, for example, within a wired and/or a wireless medium.

Data is streamed, or otherwise provided, to the system 140, in various embodiments, using a wireless network such as a Wi-Fi network, for example IEEE 802.11 (IEEE refers to the Institute of Electrical and Electronics Engineers). The Wi-Fi signal of these embodiments is received over the communications channel 152 and the communications interface 150 which are adapted for Wi-Fi communications. The communications channel 152 of these embodiments is typically connected to an access point or router that provides access to external networks including the Internet for allowing streaming applications and other over-the-top communications. Other embodiments provide streamed data to the system 140 using a set-top box that delivers the data over the HDMI connection of the input block 162. Still other embodiments provide streamed data to the system 140 using the RF connection of the input block 162. As indicated above, various embodiments provide data in a non-streaming manner. Additionally, various embodiments use wireless networks other than Wi-Fi, for example a cellular network or a Bluetooth network.

The system 140 can provide an output signal to various output devices, including a display 166, speakers 168, and other peripheral devices 170. The display 166 of various embodiments includes one or more of, for example, a touchscreen display, an organic light-emitting diode (OLED) display, a curved display, and/or a foldable display. The display 166 can be for a television, a tablet, a laptop, a cell phone (mobile phone), or other device. The display 166 can also be integrated with other components (for example, as in a smart phone), or separate (for example, an external monitor for a laptop). The other peripheral devices 170 include, in various examples of embodiments, one or more of a stand-alone digital video disc (or digital versatile disc) (DVR, for both terms), a disk player, a stereo system, and/or a lighting system. Various embodiments use one or more peripheral devices 170 that provide a function based on the output of the system 140. For example, a disk player performs the function of playing the output of the system 140.

In various embodiments, control signals are communicated between the system 140 and the display 166, speakers 168, or other peripheral devices 170 using signaling such as AV.Link, Consumer Electronics Control (CEC), or other communications protocols that enable device-to-device control with or without user intervention. The output devices can be communicatively coupled to system 140 via dedicated connections through respective interfaces 154, 156, and 158. Alternatively, the output devices can be connected to system 140 using the communications channel 152 via the communications interface 150. The display 166 and speakers 168 can be integrated in a single unit with the other components of system 140 in an electronic device such as, for example, a television. In various embodiments, the display interface 154 includes a display driver, such as, for example, a timing controller (T Con) chip.

The display 166 and speaker 168 can alternatively be separate from one or more of the other components, for example, if the RF portion of input 162 is part of a separate set-top box. In various embodiments in which the display 166 and speakers 168 are external components, the output signal can be provided via dedicated output connections, including, for example, HDMI ports, USB ports, or COMP outputs.

The system 140 may include one or more sensor devices 160. Examples of sensor devices that may be used include one or more GPS sensors, gyroscopic sensors, accelerometers, light sensors, cameras, depth cameras, microphones, and/or magnetometers. Such sensors may be used to determine information such as user's position and orientation. Where the system 140 is used as the control module for an extended reality display (such as control modules), the user's position and orientation may be used in determining how to render image data such that the user perceives the correct portion of a virtual object or virtual scene from the correct point of view. In the case of head-mounted display devices, the position and orientation of the device itself may be used to determine the position and orientation of the user for the purpose of rendering virtual content. In the case of other display devices, such as a phone, a tablet, a computer monitor, or a television, other inputs may be used to determine the position and orientation of the user for the purpose of rendering content. For example, a user may select and/or adjust a desired viewpoint and/or viewing direction with the use of a touch screen, keypad or keyboard, trackball, joystick, or other input. Where the display device has sensors such as accelerometers and/or gyroscopes, the viewpoint and orientation used for the purpose of rendering content may be selected and/or adjusted based on motion of the display device.

The embodiments can be carried out by computer software implemented by the processor 142 or by hardware, or by a combination of hardware and software. As a non-limiting example, the embodiments can be implemented by one or more integrated circuits. The memory 144 can be of any type appropriate to the technical environment and can be implemented using any appropriate data storage technology, such as optical memory devices, magnetic memory devices, semiconductor-based memory devices, fixed memory, and removable memory, as non-limiting examples. The processor 142 can be of any type appropriate to the technical environment, and can encompass one or more of microprocessors, general purpose computers, special purpose computers, and processors based on a multi-core architecture, as non-limiting examples.

FIG. 1B is a schematic side view illustrating an example waveguide display that may be used with extended reality (XR) applications according to some embodiments. An image is projected by an image generator 172. The image generator 172 may use one or more of various techniques for projecting an image. For example, the image generator 172 may be a laser beam scanning (LBS) projector, a liquid crystal display (LCD), a light-emitting diode (LED) display (including an organic LED (OLED) or micro LED (μLED) display), a digital light processor (DLP), a liquid crystal on silicon (LCoS) display, or other type of image generator or light engine.

Light representing an image 182 generated by the image generator 172 is coupled into a waveguide 174 by a diffractive in-coupler 176. The in-coupler 176 diffracts the light representing the image 182 into one or more diffractive orders. For example, light ray 178, which is one of the light rays representing a portion of the bottom of the image, is diffracted by the in-coupler 176, and one of the diffracted orders 180 (e.g. the second order) is at an angle that is capable of being propagated through the waveguide 174 by total internal reflection. The image generator 172 displays images as directed by a control module 190, which operates to render image data, video data, point cloud data, or other displayable data.

At least a portion of the light 180 that has been coupled into the waveguide 174 by the diffractive in-coupler 176 is coupled out of the waveguide by a diffractive out-coupler 184. At least some of the light coupled out of the waveguide 174 replicates the incident angle of light coupled into the waveguide. For example, in the illustration, out-coupled light rays 186a, 186b, and 186c replicate the angle of the in-coupled light ray 178. Because light exiting the out-coupler replicates the directions of light that entered the in-coupler, the waveguide substantially replicates the original image 182. A user's eye 187 can focus on the replicated image.

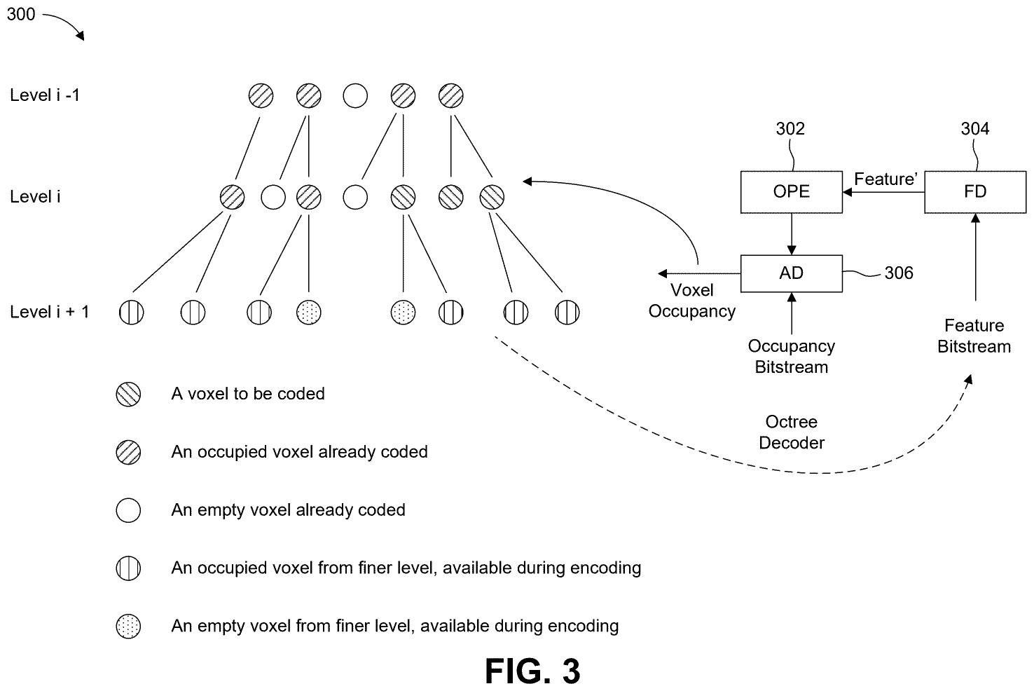

In the example of FIG. 1B, the out-coupler 184 out-couples only a portion of the light with each reflection allowing a single input beam (such as beam 178) to generate multiple parallel output beams (such as beams 186a, 186b, and 186c). In this way, at least some of the light originating from each portion of the image is likely to reach the user's eye even if the eye is not perfectly aligned with the center of the out-coupler. For example, if the eye 187 were to move downward, beam 186c may enter the eye even if beams 186a and 186b do not, so the user can still perceive the bottom of the image 182 despite the shift in position. The out-coupler 184 thus operates in part as an exit pupil expander in the vertical direction. The waveguide may also include one or more additional exit pupil expanders (not shown in FIG. 3A) to expand the exit pupil in the horizontal direction.

In some embodiments, the waveguide 174 is at least partly transparent with respect to light originating outside the waveguide display. For example, at least some of the light 188 from real-world objects (such as object 189) traverses the waveguide 174, allowing the user to see the real-world objects while using the waveguide display. As light 188 from real-world objects also goes through the diffraction grating 184, there will be multiple diffraction orders and hence multiple images. To minimize the visibility of multiple images, it is desirable for the diffraction order zero (no deviation by 184) to have a great diffraction efficiency for light 188 and order zero, while higher diffraction orders are lower in energy. Thus, in addition to expanding and out-coupling the virtual image, the out-coupler 184 is preferably configured to let through the zero order of the real image. In such embodiments, images displayed by the waveguide display may appear to be superimposed on the real world.

FIG. 1C is a schematic side view illustrating an example alternative display type that may be used with extended reality applications according to some embodiments. In an XR head-mounted display device 191, a control module 192 controls a display 193, which may be an LCD, to display an image. The head-mounted display includes a partly-reflective surface 194 that reflects (and in some embodiments, both reflects and focuses) the image displayed on the LCD to make the image visible to the user. The partly-reflective surface 194 also allows the passage of at least some exterior light, permitting the user to see their surroundings.

FIG. 1D is a schematic side view illustrating an example alternative display type that may be used with extended reality applications according to some embodiments. In an XR head-mounted display device 195, a control module 196 controls a display 197, which may be an LCD, to display an image. The image is focused by one or more lenses of display optics 198 to make the image visible to the user. In the example of FIG. 1D, exterior light does not reach the user's eyes directly. However, in some such embodiments, an exterior camera 199 may be used to capture images of the exterior environment and display such images on the display 197 together with any virtual content that may also be displayed.

The embodiments described herein are not limited to any particular type or structure of XR display device.

A User Equipment (UE) may correspond to any extended Reality (XR) device/node which may come in variety of form factors. Typical UE (e.g., XR UE) may include, but not limited to the following: Head Mounted Displays (HMD), optical see-through glasses and video see-through HMDs for Augmented Reality (AR) and Mixed Reality (MR), mobile devices with positional tracking and camera, wearables etc. In addition to the above, several different types of XR UE may be envisioned based on XR device functions for e.g., as display, camera, sensors, sensor processing, wireless connectivity, XR/Media processing, and power supply, to be provided by one or more devices, wearables, actuators, controllers and/or accessories. One or more device/nodes/UEs may be grouped into a collaborative XR group for supporting any of XR applications/experience/services.

### Point Cloud Data Format

The present application is related to the field of point cloud compression and processing. The field of point cloud compression and processing aims to develop tools for compression, analysis, interpolation, representation and understanding of input signals, such as point clouds.

Point cloud data is a universal data format across several business domains from autonomous driving, robotics, AR/VR, civil engineering, computer graphics, to the animation/movie industry. 3D LiDAR sensors have been deployed in self-driving cars, and affordable LiDAR sensors are released from Velodyne Velabit, Apple iPad Pro 2020 and Intel RealSense LiDAR camera L515. With advances in sensing technologies, 3D point cloud data becomes more practical than ever.

Point cloud data is also believed to consume a large portion of network traffic, e.g., among connected cars over 5G network, and immersive communications (VR/AR). Efficient representation formats may be necessary for point cloud understanding and communication. In particular, raw point cloud data may be organized and processed for the purposes of world modeling and sensing. Compression of raw point clouds may be used when the storage and transmission of the data are used in related scenarios.

Furthermore, point clouds may represent a sequential scan of the same scene, which contains multiple moving objects. They are called dynamic point clouds as compared to static point clouds captured from a static scene or static objects. Dynamic point clouds are typically organized into frames, with different frames being captured at different times. Dynamic point clouds may require the processing and compression to be handled in real-time or with low delay.

Each point of the point cloud may be represented by at least a 3D position (x, y, z). The set of 3D positions illustrates the geometry of the object/scene from which the point cloud is captured. Additionally, each point of the point cloud may be associated with some attributes, depending on the applications. For example, for VR/AR/Gaming, the attribute may include color (r, g, b), and for LiDAR, the attribute may include reflectance.

### Point Cloud Data Use Cases

The automotive industry and autonomous cars are domains in which point clouds may be used. Autonomous cars are able to “probe” their environment to make good driving decisions based on the reality of their immediate surroundings. Typical sensors, like LiDARs, produce (dynamic) point clouds that are used by the perception engine. These point clouds are not intended to be viewed by human eyes, and they are typically sparse, not necessarily colored, and dynamic with a high frequency of capture. They may have other attributes, like the reflectance ratio provided by the LiDAR because this attribute may be indicative of the material of the sensed object, and this attribute may help in making a decision.

Virtual Reality (VR) and immersive worlds have become a hot topic and are foreseen by many as the future of 2D flat video. The viewer is immersed in an environment all around the viewer as opposed to standard TV, where the viewer may look only at the virtual world in front of the viewer. There are several gradations in the immersivity depending on the freedom of the viewer in the environment. Point clouds are a good format candidate to distribute VR worlds. They may be static or dynamic and are typically of average size, with, e.g., no more than millions of points at a time.

Point clouds also may be used for various purposes, such as cultural heritage/buildings in which objects like statues or buildings are scanned in 3D to share the spatial configuration of the object without sending or visiting the statues or buildings. Also, point clouds offer a way to ensure preservation of the knowledge of the object in case the original object, for instance, is destroyed by an earthquake. Such point clouds are typically static, colored, and huge.

Another use case is in topography and cartography in which using 3D representations, maps are not limited to the plane and may include the relief. Google Maps is a good example of 3D maps but is understood to use meshes instead of point clouds. Nevertheless, point clouds may be a suitable data format for 3D maps, and such point clouds are typically static, colored, and huge.

World modeling and sensing via point clouds may be a technology that allows machines to gain knowledge about the 3D world around them, which may be used by the applications discussed above.

### General Challenges

3D point cloud data include discrete samples of the surfaces of objects or scenes. A huge number of points may be used to fully represent the real world with point samples. For instance, a typical VR immersive scene contains millions of points, while point clouds typically contain hundreds of millions of points. Therefore, the processing of such large-scale point clouds may be computationally expensive, especially for consumer devices, such as smartphones, tablets, and automotive navigation systems, that have limited computational power.

The first step for processing or inference on a point cloud is to have efficient storage methodologies. To store and process the input point cloud with affordable computational cost, the point cloud may be down-sampled first, in which the down-sampled point cloud summarizes the geometry of the input point cloud while having much fewer points. The down-sampled point cloud may be inputted into a machine task for further processing. However, further reduction in storage space may be achieved by converting the raw point cloud data (original or down sampled) into a bitstream through entropy coding techniques for lossless compression.

In addition to lossless coding, many scenarios may use lossy coding for significantly improved compression ratio while maintaining the induced distortion under certain quality levels. To achieve a less lossy coding, an efficient point feature extractor may be used to improve the accuracy of the reconstruction within the given resource budget.

### Learning-Based Point Cloud Compression

Since point cloud data is composed of two components: geometry information and attribute information, the compression of point clouds can be classified into two categories: geometry coding and attribute coding.

Examples of existing learning-based point cloud geometry compression techniques are deep octree coding, end-to-end feature-based geometry coding. With deep octree coding, neural network-based models are utilized to estimate the occupancy probabilities. Such estimated probabilities are then used to help the arithmetic coder to encode or decode a binary flag indicating whether a child octree voxel is occupied or empty.

This application discusses the problem of dynamic point cloud compression, which benefits both feature-based geometry coding as well as octree coding. Point cloud compression is a problem affecting many applications, such as autonomous driving, robotics, AR/VR, civil engineering, computer graphics, to the animation/movie industry. This application discusses dynamic point cloud compression based on deep learning and sparse tensor processing, which compresses an input point cloud given a reference point cloud.

As understood, most previous learning-based dynamic point cloud compression techniques are either designed for lossless octree coding or lossy feature-based coding.

In the '479 application, a reference frame is used to assist the coding of current point cloud features in a lossy compression system. In the '677 application, a reference frame is used to assist the lossless coding of an octree representing the current frame.

The '144 application, which is a point cloud coding technique utilizing features from the finer level to unify lossless and lossy point cloud coding in a hierarchical manner, is extended to the coding of dynamic point cloud sequences. The methodology of the '144 application, which is an intra coding method, may serve as a starting point for this application for some embodiments.

### Octree Encoding

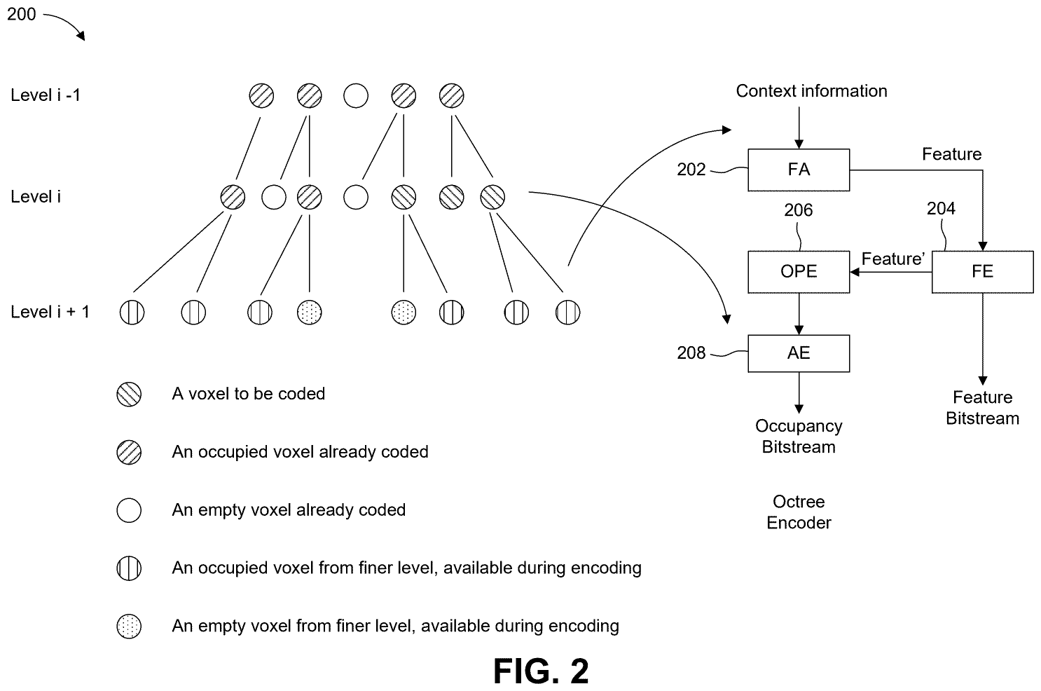

FIG. 2 is a process diagram illustrating an example octree encoding process according to some embodiments. The process 200 includes four steps for some embodiments. Step 1 is a feature extractor/aggregator FA 202. The feature extractor/aggregator uses the finer (child) level of details as its input. Because the finer level of voxels has more detailed information compared to voxels from a parent level, extraction of more representative features may be “easier” for some embodiments. Step 2 is a feature encoder FE 204. The features generated from Step 1 are encoded into bitstreams. In addition to generating the bitstream, the feature encoder also outputs the reconstructed feature. In some embodiments, the reconstructed feature is a quantized/dequantized version of the feature from Step 1. The reconstructed feature should match the decoded features of a decoder. Step 3 is an occupancy probability estimator (OPE) 206 using a neural network model. The OPE 206 takes the reconstructed feature as its input and computes the occupancy probability of a current octree voxel. Step 4 is an arithmetic encoder (AE) 208. Based on the estimated probability, the arithmetic encoder 208 encodes the occupancy information of the current octree voxel into a bitstream.

### Octree Decoding

FIG. 3 is a process diagram illustrating an example octree decoding process according to some embodiments. The decoding method 300, which has 3 steps for some embodiments, corresponds to the encoding method of FIG. 2. Step 1 is a feature decoder (FD) 304, which decodes a feature from the input bitstream. The decoder relies on a coded feature rather than extracting the feature from scratch. The decoder benefits from a more representative feature because the features are extracted using a finer level of detail than from the parent level that previous methods are understood to use. Step 2 is an occupancy probability estimator (OPE) 302. This step is the same as Step 3 in the encoding method in FIG. 2. The OPE 302 computes an occupancy probability of the next octree voxel. Step 3 is an arithmetic decoder (AD) 306. Based on the estimated probability, the arithmetic decoder 306 determines if the next octree voxel is occupied or empty.

### Full Compression Framework

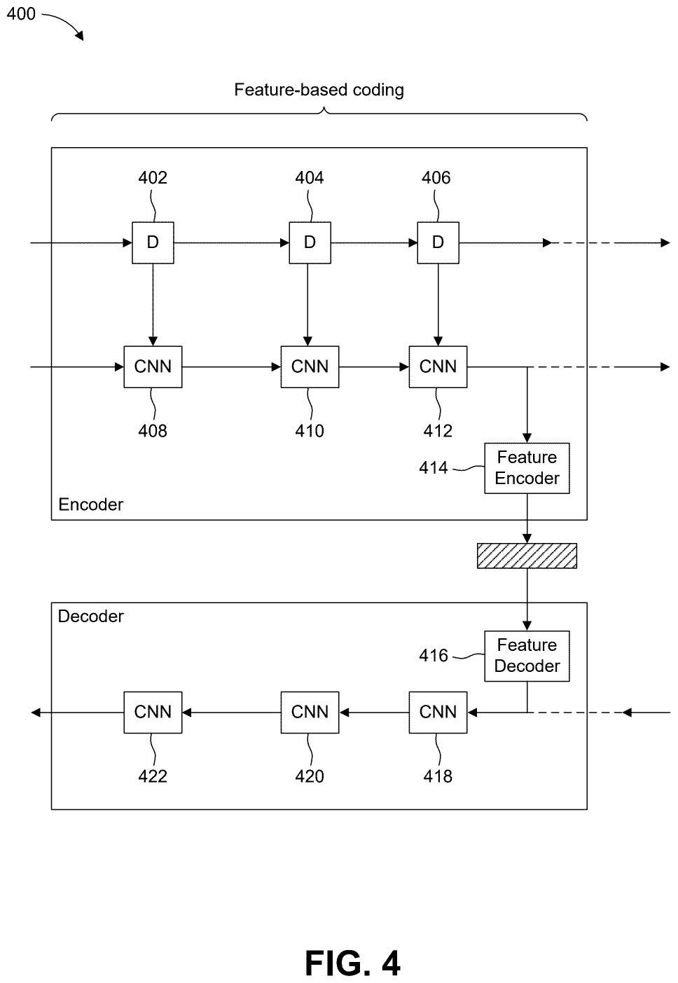

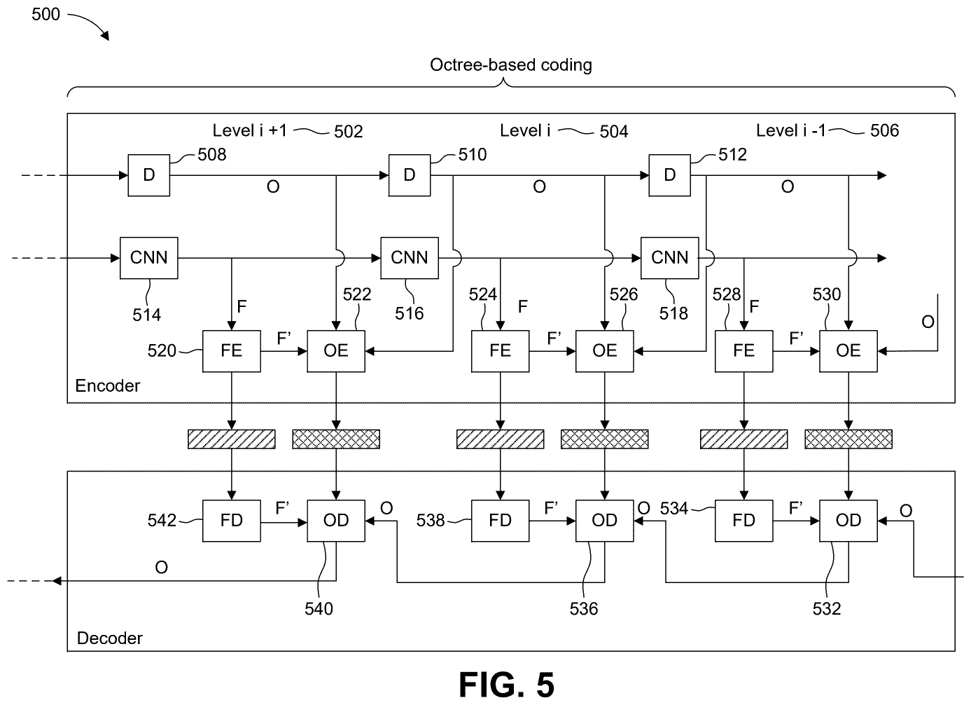

For some embodiments, a compression pipeline may include a feature-coding process (e.g., FIG. 4) combined with an octree-coding process (e.g., FIG. 5).

### Feature-Based Coding in a Full Compression Framework

FIG. 4 is a process diagram illustrating an example feature coding process for point cloud coding based on finer-level features according to some embodiments. A feature-based encoding and decoding method 400 is shown in FIG. 4. The encoder, which is shown in the top part of the figure, has a few CNN-like neural network blocks 408, 410, 412. They extract and aggregate a feature map from the input, for example, point cloud frames. During feature extraction and aggregation, the resolution of the input is typically downsampled via downsampling operations that may include a downsampling block 402, 404, 406 that outputs to a CNN block 408, 410, 412. Finally, the extracted feature is sent to a feature encoder (FE) block 414 to output a bitstream.

The decoder, which is shown in the bottom part of FIG. 4, has a few CNN-like neural network blocks 418, 420, 422. They correspond to the few CNN-like neural network blocks 408, 410, 412 in the encoder. Instead of performing downsampling/pooling, the CNN-like neural network blocks 418, 420, 422 reconstruct the input (e.g., a point cloud) via upsampling/unpooling of the output of the feature decoder 416.

The CNN blocks 418, 420, 422 may be enhanced or replaced by MLP or some other neural network blocks, such as the Inception ResNet (IRN) or Transformer blocks, for some embodiments.

### Octree-Based Coding in a Full Compression Framework

FIG. 5 is a process diagram illustrating an example octree coding process for point cloud coding based on finer-level features according to some embodiments. In conjunction with the feature-based coding described earlier, the octree-based coding of the '144 application is shown in FIG. 5.

First, for the octree coding process 500, a few CNNs 514, 516, 518 in the top are used during encoding and they downsample the point cloud. As mentioned in the '144 application, the features extracted by the CNNs 514, 516, 518 are encoded by feature encoders 520, 524, 528 into bitstreams. In some earlier methods, the features are not coded. The feature F′ outputs are used to assist the octree encoding (OE) blocks 522, 526, 530.

For some embodiments, a series of downsampling blocks 508, 510, 512 may be used to generate inputs to the octree-encoding blocks 522, 526, 530.

On decoder side, the feature is decoded by FD blocks 534, 538, 542. The decoded feature is used to assist the octree decoding OD blocks 532, 536, 540.

The direction to perform feature extraction by CNNs is from left to right. This structure indicates that the feature extraction is based on a finer level of an octree. All voxels in the current level may be used because the encoder has access to the whole octree. Other designs may not transmit the feature bitstream, and such designs may not use any voxel not yet decoded for feature extraction.

In some embodiments, the feature outputted for use at level i 504 is generated with every voxel that is occupied at level i. This methodology may also be applied for level i+1 502 and level i−1 506 for some embodiments. In addition, features are also generated for non-occupied voxels if its parent voxel is occupied. These features are later used by octree encoding OE 522, 526, 530 and octree decoding OD 532, 536, 540 to compute the occupancy probabilities.

This application discusses a dynamic point cloud compression method that differs from the literature work which unifies the motion estimation and motion compensation of the lossy (feature-based) and lossless (octree-based) coding.

As understood, this application provides a more efficient way to code the dynamic point cloud in a tree structure. The encoder uses finer levels of detail to extract motion feature for a current and a reference point cloud. The extracted features are used to generate the predicted feature, which facilitate the coding of the feature of the current point cloud. The inter coding occurs in each octree level, which fully utilizes the interdependency between point cloud frames to enhance the coding performance.

### Feature Aggregator—Design 1

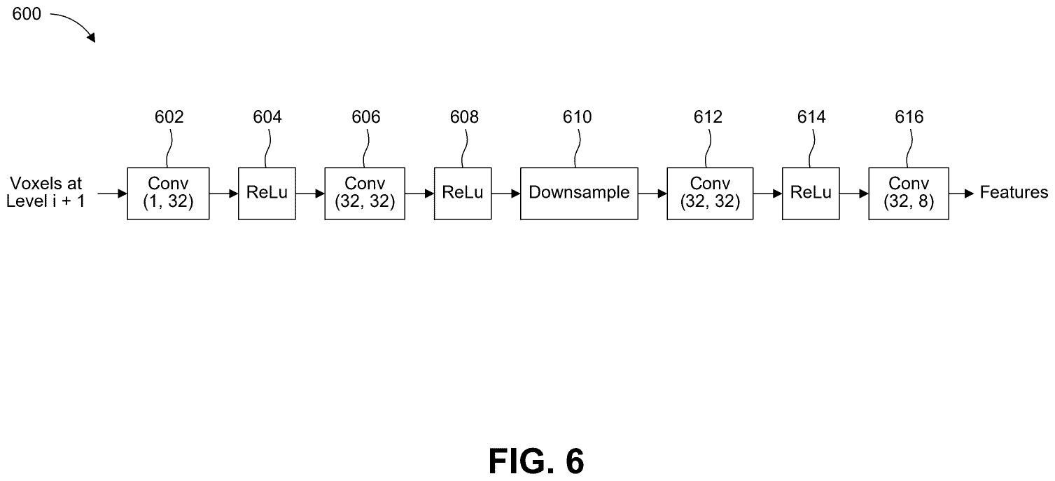

FIG. 6 is a process diagram illustrating an example feature aggregator with only one level as an input according to some embodiments. An example feature aggregator (FA) 600 is shown in FIG. 6. In this diagram, the feature extractor takes the immediate next level of voxel as an input to extract features. No feature is propagated from earlier levels.

The example feature aggregator (FA) 600 is composed of several 3D convolutional layers. For the “Conv” blocks 602, 606, 612, 616 in FIG. 6, Conv (x, y) means the input feature channel size is x, while the output feature channel size is y. The “Downsample” block 610 downsamples the feature from the (i+1)-th level to the i-th level. The convolutional blocks 602, 606, 612 may be followed by a ReLU block 604, 608, 614.

In some embodiments, the convolutional layers may be replaced with other commonly used feature aggregation blocks, such as an Inception ResNet (IRN) block, and a Transformer block, and these blocks may be repeated several times to enhance the feature aggregation performance.

### Feature Aggregator—Design 2

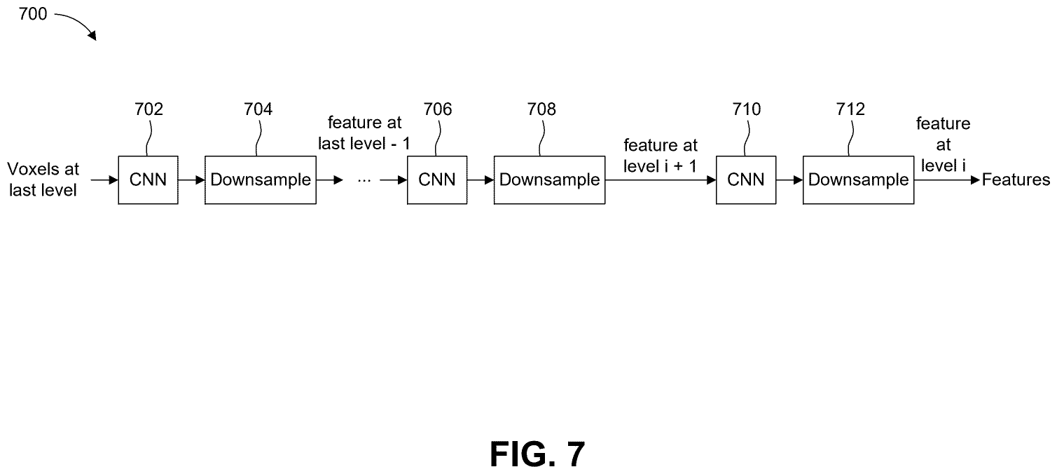

FIG. 7 is a process diagram illustrating an example feature aggregator with an aggregated feature as an input according to some embodiments. In some embodiments, the feature extractor 700 is shown in FIG. 7. The feature extraction and aggregation start from the finest (last) level of an octree. Compared to the earlier design in FIG. 6, the aggregated feature may be more powerful, because the aggregated feature undergoes a deeper network to propagate the feature all the way from the finest level to the current level.

This design of the feature aggregator (FA) 700 includes several 3D convolutional neural network (CNN) blocks 702, 706, 710 followed by downsampling blocks 704, 708, 712. The CNN block may be composed of a series of back-to-back 3D convolutional layers. The “Downsample” blocks gradually downsample the feature from the last (finest) level to the i-th level.

In some embodiments, the CNN blocks may be replaced with other commonly used feature aggregation blocks, such as an Inception ResNet (IRN) block, and a Transformer block, and these blocks may be repeated several times to enhance the feature aggregation performance.

### Feature Encoder Using Uniform Quantization—Design 1

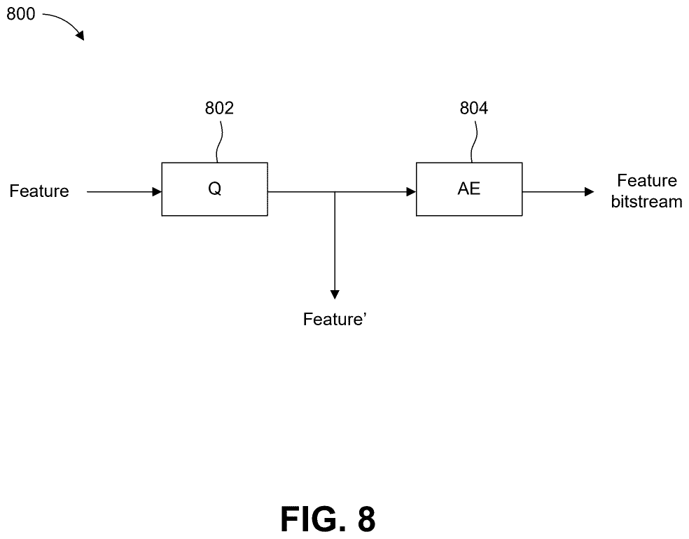

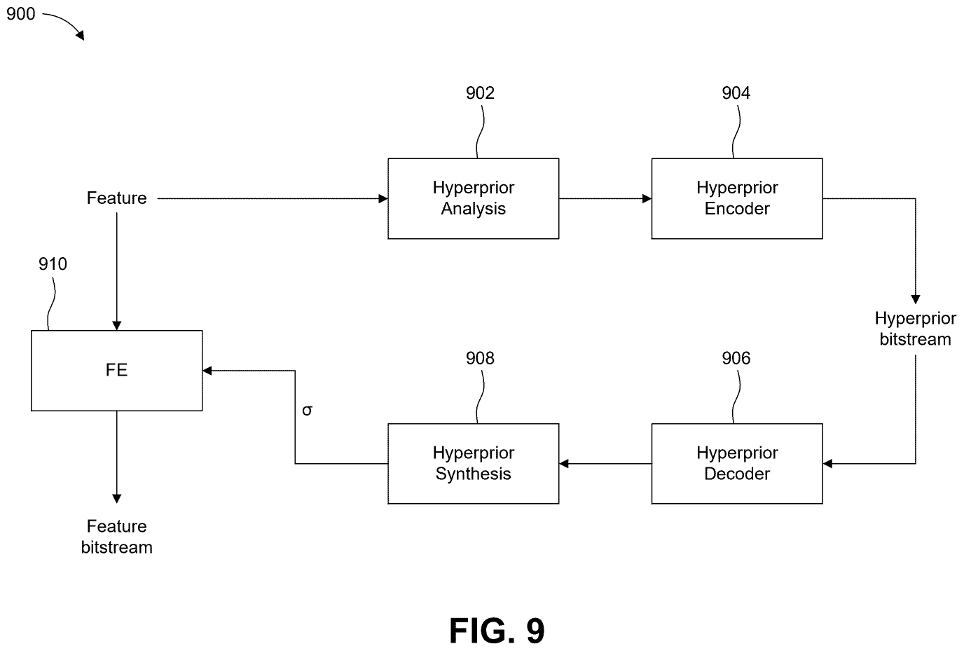

FIG. 8 is a process diagram illustrating an example feature encoder using uniform quantization according to some embodiments. The feature encoder may be implemented in various ways. In this design, the feature encoder 800 shown in FIG. 8 is composed of two steps. In Step 1, the feature is quantized (Q) 802 based on a quantization step. The selection of quantization step may be a pre-selected parameter based on a rate distortion requirement. In Step 2, the quantized feature is arithmetically encoded (AE) 804 into a feature bitstream. The feature encoder of FIG. 8 may be less complex compared to the second design of feature encoder, which is shown in FIG. 9.

### Feature Encoder Using Hyperprior Encoding—Design 2

FIG. 9 is a process diagram illustrating an example feature encoder using a hyperprior encoder according to some embodiments. The feature encoder 900 shown in FIG. 9 uses a hyperprior encoder, which is discussed in, for example, Ballé, Johannes, et al., Variational Image Compression with a Scale Hyperprior, IN INT'L CONF. ON LEARNING REPRESENTATIONS (2018). The purpose of this design is to analyze and utilize the distribution of the feature to perform efficient arithmetic coding of the feature.

In Step 1, the first feature is sent to a “hyperprior analysis” block 902 to aggregate a hyperprior feature that is more abstract than the input feature. The hyperprior feature may be “easier” to encode for some embodiments. The hyperprior feature is used to compute the hyperprior parameters later. In Step 2, the hyperprior features are encoded by a hyperprior encode process 904 into a hyperprior bitstream. For some embodiments, the hyperprior bitstream may undergo some quantization and arithmetic encoding.

In Step 3, the hyperprior bitstream goes through an arithmetically decode process 906 and is dequantized to output a reconstructed hyperprior feature. In Step 4, the reconstructed hyperprior feature is sent to a “hyperprior synthesis” block 908 to compute the distribution parameters of the initial (first) feature. In the embodiment shown in FIG. 9, the distribution parameters include variance parameters of the initial feature. In another design, the distribution parameters include both the mean and the variance parameters of the initial feature. In Step 5, the estimated hyperprior parameters (mean and variance) are provided to an arithmetic encoder (FE) 910 to encode the first feature.

The hyperprior encoder of FIG. 9 may provide higher coding performance. The “hyperprior analysis” block 902 and “hyperprior synthesis” block 908 are typically learnable neural network blocks for some embodiments.

### Occupancy Probability Estimator (OPE)

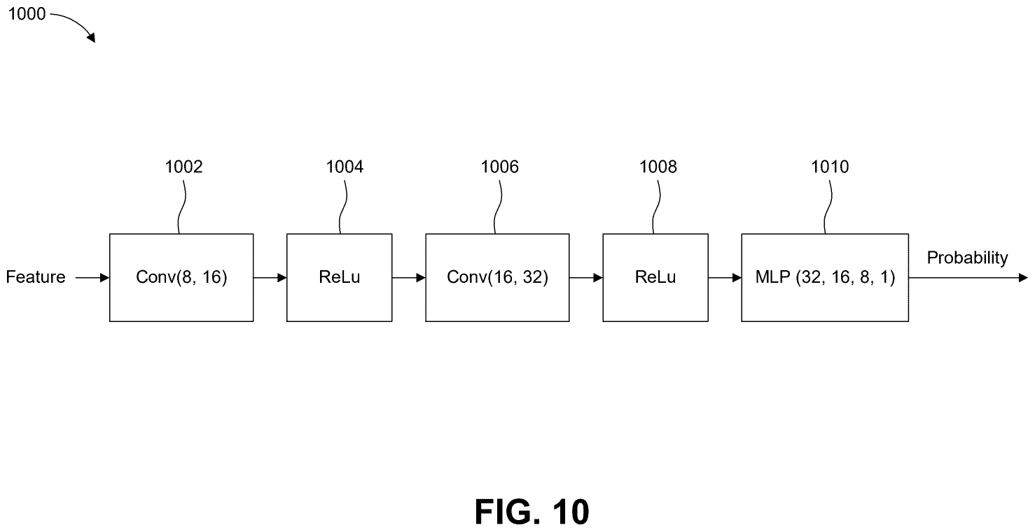

FIG. 10 is a process diagram illustrating an example occupancy probability estimator according to some embodiments. An occupancy probability estimator may be used in both an encoder and a decoder. An occupancy probability estimator (OPE) 1000 is shown in FIG. 10. Firstly, the feature is further aggregated/refined by a few convolutional layers 1002, 1006 (two conv( ) layers in the example of FIG. 10). Each convolutional layer 1002, 1006 may go through a ReLU block 1004, 1008. The output of the second ReLU block 1008 is passed to a multilayer perceptron (MLP) 1010 to compute the probability. In FIG. 10, the notation “(32, 6, 8, 1)” in the MLP block 1010 indicates the channel size of the MLP layers. In the end, the occupancy probability is a scalar number. Therefore, the output channel of the MLP is one (1) channel.

### Feature Decoder Using Uniform Quantization—Design 1

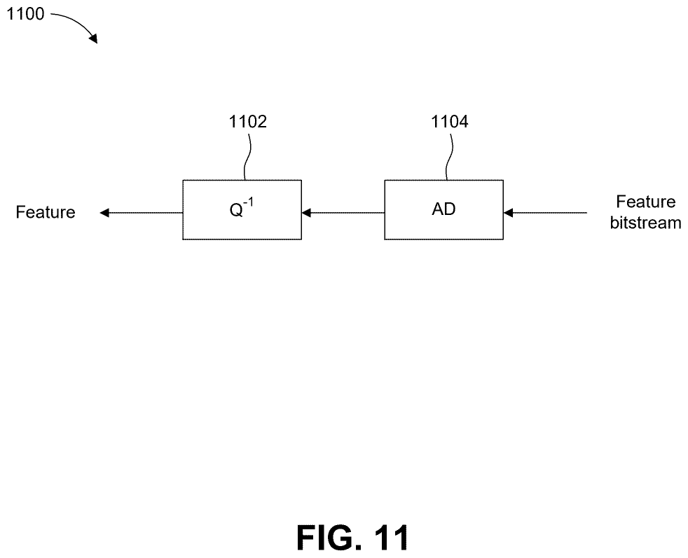

FIG. 11 is a process diagram illustrating an example feature decoder according to some embodiments. FIG. 11 shows an example feature decoder 1100. This feature decoder 1100 corresponds to the encoder shown in FIG. 8. First, the input bitstream is arithmetically decoded (AD) 1104. Next, a dequantization step (Q-1) 1102 is conducted to output the decoded feature(s).

### Feature Decoder Using Hyperprior Decoding—Design 2

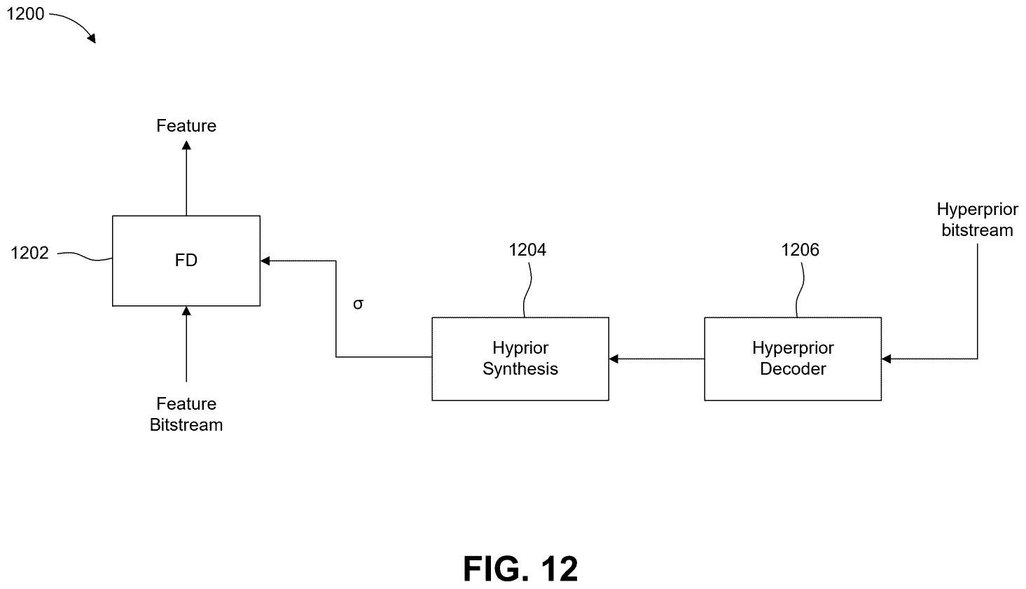

FIG. 12 is a process diagram illustrating an example feature decoder using a hyperprior decoder according to some embodiments. FIG. 12 shows an example feature decoder 1200. This decoder 1200 corresponds to the encoder shown in FIG. 9.

In Step 1, the coded hyperprior features are arithmetically decoded from a bitstream by a hyperprior decoder 1206. In Step 2, the hyperprior features are sent to a “hyperprior synthesis” block 1204 to generate the distribution parameters to be used in the next step. In the design of FIG. 12, the distribution parameters may include the variance. In some embodiments, the distribution parameters may include both the mean and the variance parameters. In Step 3, the features coded in a bitstream are arithmetically decoded by a feature decoder (FD) 1202 based on the estimated hyperprior parameters.

The “hyperprior synthesis” block and the “hyperprior decoder” block may be the same as the blocks/models shown in FIG. 9. The “FD” block 1202 performing arithmetic decoding of the feature corresponds to the “FE” block performing arithmetic encoding of feature in FIG. 9.

### Octree Encoding and Decoding

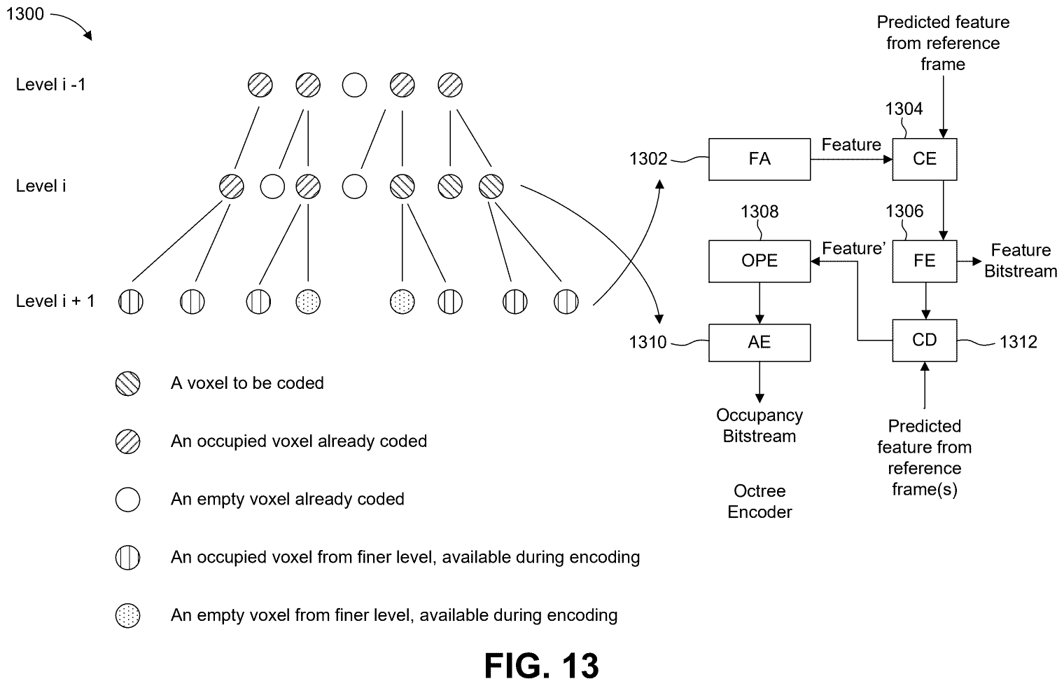

FIG. 13 is a process diagram illustrating an example octree encoding according to some embodiments. Compared to FIG. 2, FIG. 13 introduces additional blocks, which is the conditional encoder (CE) block 1304 and conditional decoder (CD) block 1312 to further process the feature output from the feature aggregator (FA) 1302. Suppose the process 1300 obtains, from the reference frame(s), a predicted feature, which serves as a prediction of the current feature.

The CE 1304 aims at removing the redundant information from the current feature, which is already conveyed by the predicted feature. In this way, the output of CE 1304 contains less information and becomes easier to encode, leading to a smaller bitstream. Next, the FE block 1306 encodes the output of the CE block 1304, it also outputs the dequantized feature to the CD block 1312. The CD block 1312 adds back the removed information by the CE block 1304. The CD block outputs the reconstructed feature, which is provided to the OPE block to assist the occupancy encoding. The output of the OPE block 1308 is sent to an AE block 1310. The arithmetic encoder 1310 outputs the occupancy bitstream.

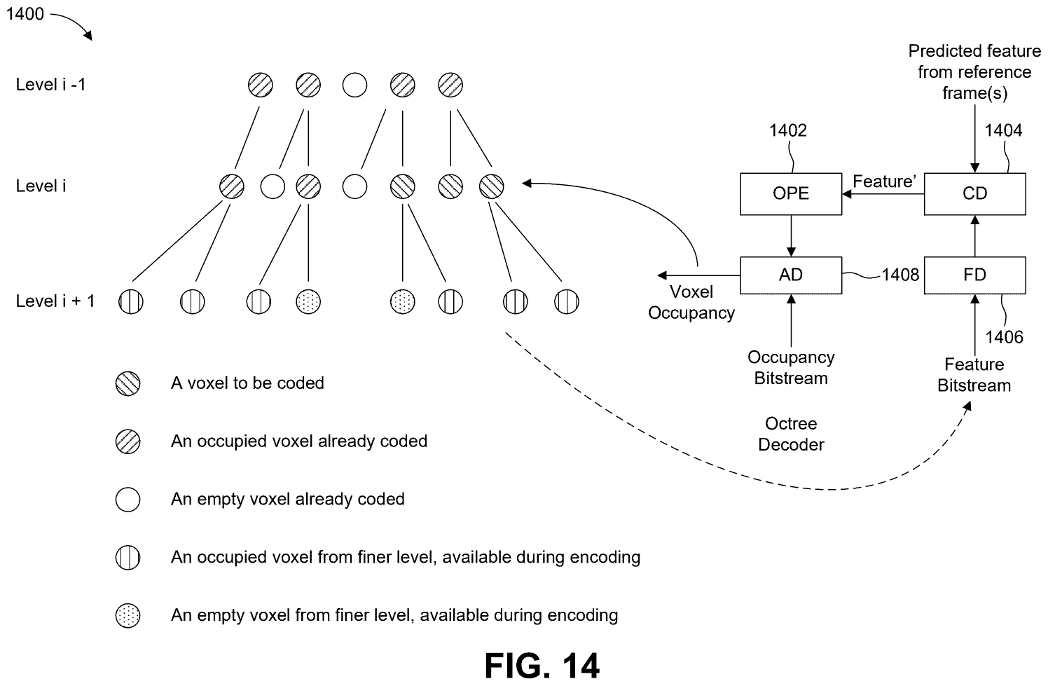

FIG. 14 is a process diagram illustrating an example octree decoding according to some embodiments. Compared to FIG. 3, FIG. 14 introduces an additional block, which is the conditional decoder (CD) block 1404 to decode the feature output from the feature decoder (FD) 1406. The CD block 1404 in FIG. 14 is the same as the CD block 1312 in FIG. 13 for some embodiments. Given the reference frame(s), the same predicted feature on the encoder side (FIG. 13) is obtained on the decoder side, which serves as a prediction of the feature for the voxel occupancies. The CD block 1404 aims to add back the information from the predicted feature to the decoded feature, so that a complete feature describing the voxel occupancies at the current level may be obtained. In this way, the output of the CD block 1404 may be readily used for subsequent occupancy probability estimation for the decoding of the octree.

The output of the CD block 1404 is passed to the OPE block 1402. The output of the OPE block 1402 is sent to an AD block 1408. The arithmetic decoder 1408 takes as inputs the occupancy bitstream and the OPE block output to generate the voxel occupancy.

### Conditional Encoder and Conditional Decoder

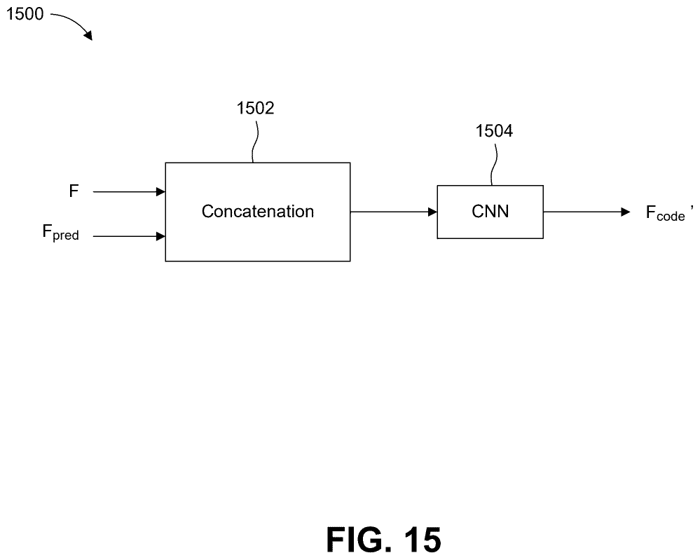

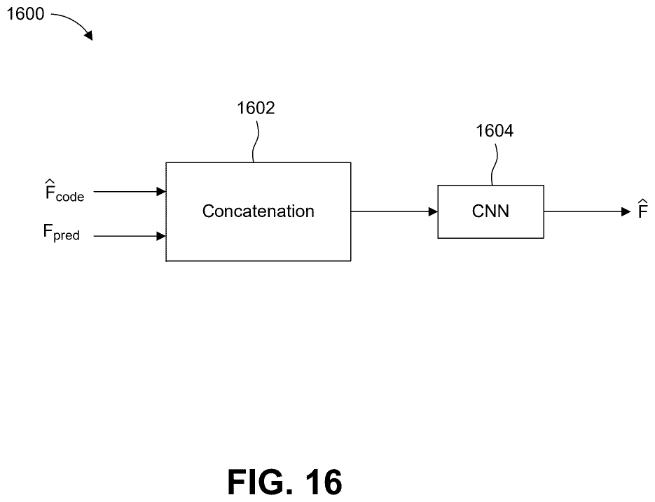

FIG. 15 is a process diagram illustrating an example conditional encoder according to some embodiments. The structures of the conditional encoder and conditional decoder, which are provided in FIGS. 15 and 16, respectively, have basically the same structure.

The conditional encoder (FIG. 15) 1500 takes as inputs the current feature extracted from the current point cloud and a predicted feature obtained from the reference point cloud(s) and performs a concatenation process 1502. After that, the concatenated feature is inputted to a CNN block 1504 to output the feature to be encoded.

FIG. 16 is a process diagram illustrating an example conditional decoder according to some embodiments. The conditional decoder (FIG. 16) 1600 takes as inputs the reconstructed feature and the predicted feature and performs concatenation process 1602. The concatenated feature is processed by a CNN block 1604, which outputs the reconstructed current feature.

### Full Point Cloud Compression Framework

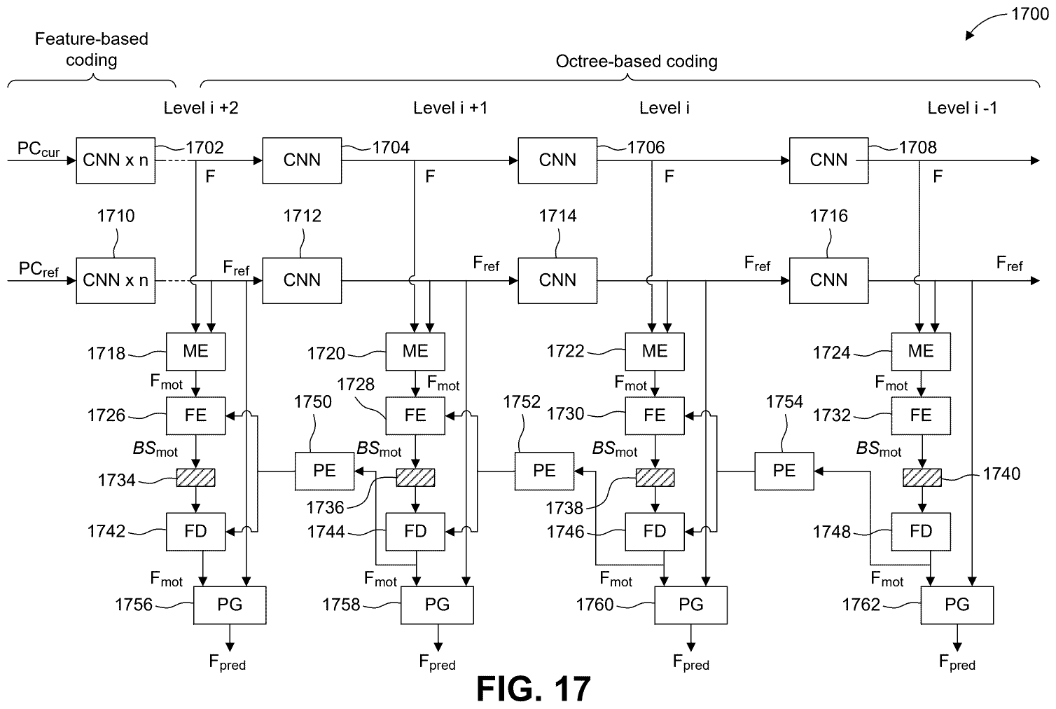

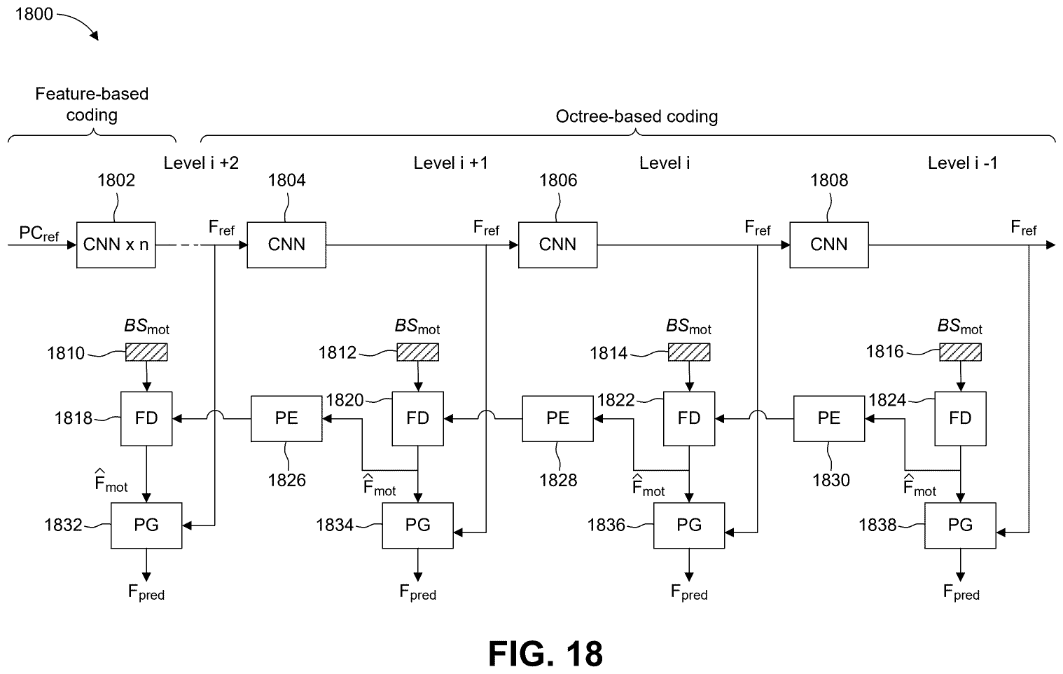

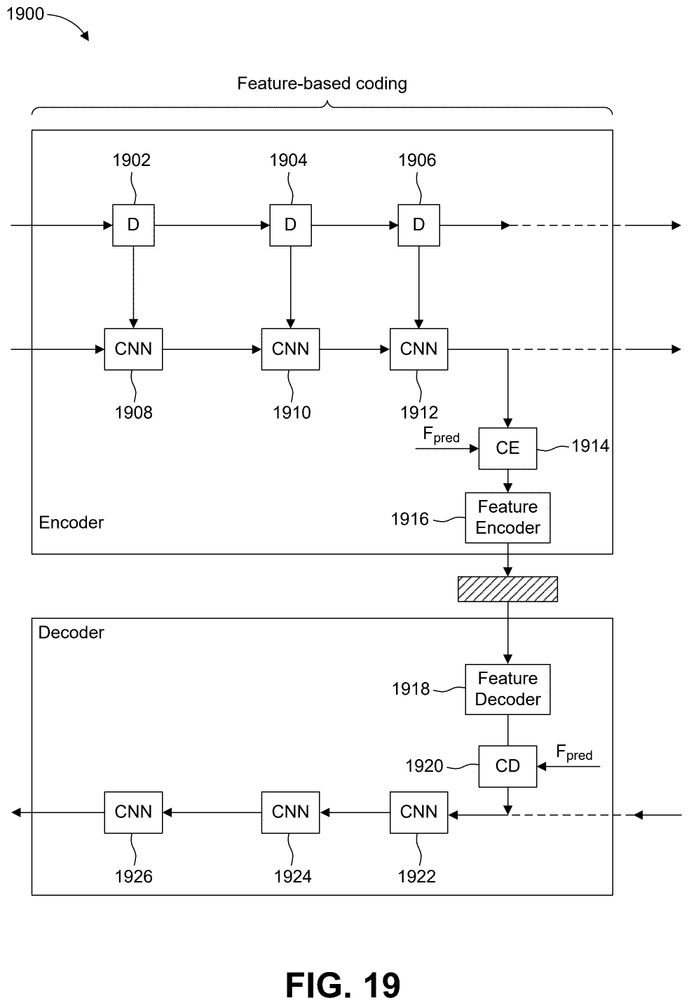

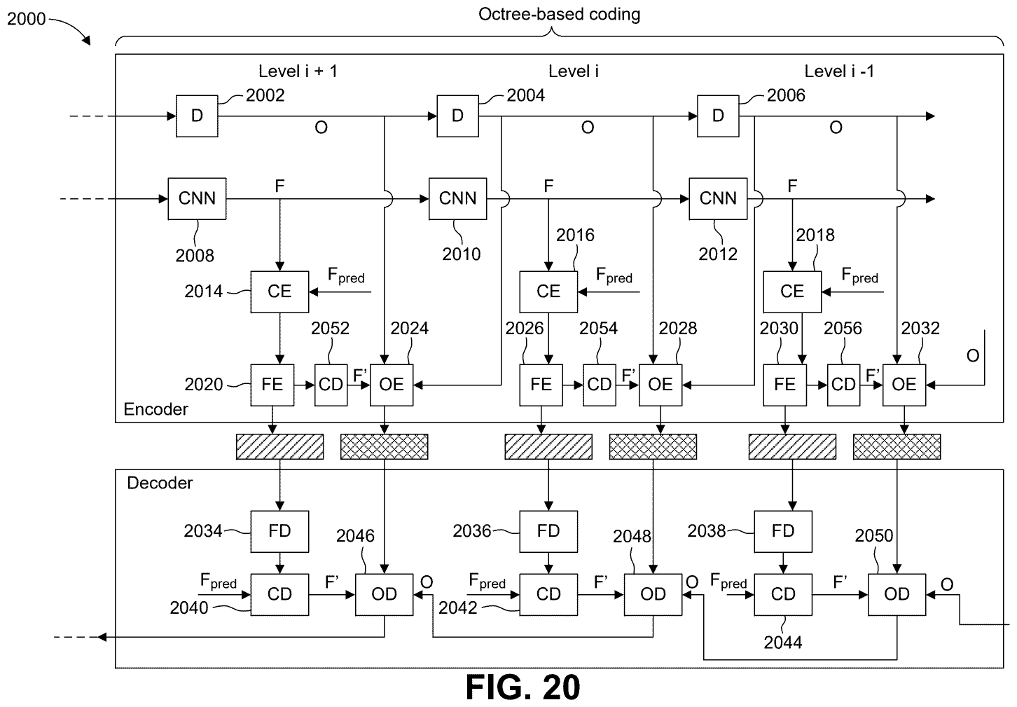

For some embodiments, a full point cloud compression framework includes two branches: the inter-branch (FIGS. 17 and 18) and the main branch (FIGS. 19 and 20).

### Inter Coding Branch

This section describes the inter coding branch of a compression system. The encoder part of the inter coding branch is shown in FIG. 17, while the decoding part of the inter coding branch is shown in FIG. 18.

### Encoding

FIG. 17 is a process diagram illustrating an example hierarchical inter-coding branch of an encoder according to some embodiments. Given a current point cloud PC_{cur} and a reference point cloud PC_{ref}, the inter coding branch on the encoder side aims at extracting the predicted feature F_{pred} for each octree level. First, at the top of FIG. 17, the process 1700 has a few CNN-like neural network blocks 1702, 1704, 1706, 1708, 1710, 1712, 1714, 1716. They extract and aggregate feature maps from both the current and the reference point clouds. During the feature extraction and aggregation, the resolution of the input is typically downsampled.

Next the extracted current feature (F) and the extracted reference feature (F_{ref}) are sent to a motion estimation block (ME) 1718, 1720, 1722, 1724 which outputs a motion feature Fₘₒₜ. The motion feature represents the dynamics between the two input point cloud frames, which are inputted to the feature encoder (FE) block 1726, 1728, 1730, 1732 for encoding as a motion bitstream BSₘₒₜ 1734, 1736, 1738, 1740. The motion bitstream 1734, 1736, 1738, 1740 is decoded by a feature decoder (FD) block 1742, 1744, 1746, 1748, leading to the reconstructed motion feature Êₘₒₜ. \hat{F}ₘₒₜ and reference feature (F_{ref}) are then fed to another block denoted the predictor generator block (PG) 1756, 1758, 1760, 1762 for estimating a predicted feature F_{pred}. The predictor generator block is essentially performing motion compensation for the reference feature according to the motion depicted in the reconstructed motion feature \hat{F}ₘₒₜ. The reconstructed motion feature \hat{F}ₘₒₜ is the quantized version of the motion feature motion feature Fₘₒₜ at the associated octree level. Therefore, during encoding, instead of actually launching the feature decoder blocks 1742, 1744, 1746 and 1748, some embodiments directly compute the quantized version of Fₘₒₜ to obtain the reconstructed motion feature \hat{F}ₘₒₜ.

The encoding (and decoding) of the motion feature is based on a block denoted as the parameter estimator (PE) 1750, 1752, 1754, which estimates the mean (and for some embodiments, the variance) from the previous reconstructed motion feature. For some embodiments, the PE block may be based on the hyperprior model described in FIGS. 9 and 12. However, instead of sending an additional bitstream for the hyperprior, here the parameters are estimated from the previous level. Thus, the usage of the PE blocks at each level constitutes a hierarchical hyperprior model for encoding/decoding the motion feature.

In the end, the inter coding branch, outputs the motion bitstream and outputs the predicted feature F_{pred} for the main encoding branch to perform encoding.

### Decoding

FIG. 18 is a process diagram illustrating an example hierarchical inter-coding branch of a decoder according to some embodiments. Compared to the encoding part shown in FIG. 17, the decoding part has less components for some embodiments. The decoding process 1800 directly decodes the motion bitstream 1810, 1812, 1814, 1816 with the feature decoder block FD 1818, 1820, 1822, 1824 and obtains the reconstructed motion feature \hat{F}ₘₒₜ. After that, the predictor generator (PG) block 1832, 1834, 1836, 1838 is applied to \hat{F}ₘₒₜ and the reference feature F_{ref}, leading to the predicted features to be inputted to the main decoding branch.

In the encoder part (FIG. 17) and decoder part (FIG. 18), the inputs to the CNN blocks at the octree-based coding part 1704, 1706, 1708, 1712, 1714, and 1716 in FIG. 17, and the inputs to the CNN blocks at the octree-coding part 1804, 1806, 1808 may be replaced for some embodiments by the point clouds downsampled to the associated level. For instance, for the current feature F (in FIG. 17) and reference feature F_{ref} (in both FIGS. 17 and 18) at level i+1 which are to be fed to their corresponding CNN blocks, these two features may be replaced with PC_{cur} and PC_{ref} that are downsampled to level i+1, respectively. Similarly, all the other F's and F_{ref}'s are replaced by PC_{cur} and PC_{ref} downsampled to the corresponding level. In this way, the dependency of the feature extraction is broken, and the neural network training of the inter coding branch may be performed at one level in one training iteration without considering the feature propagation, therefore reducing memory cost.

As mentioned above with regard to FIG. 17, the decoding (and encoding) of the motion feature is based on a block denoted as the parameter estimator (PE) 1826, 1828, 1830, which estimates the mean (and for some embodiments, the variance) from the previous reconstructed motion feature. For some embodiments, the PE block may be based on the hyperprior model described in FIGS. 9 and 12. However, instead of sending an additional bitstream for the hyperprior, here the parameters are estimated from reconstructed motion feature of the previous level. Thus, the usage of the PE blocks at each level constitutes a hierarchical hyperprior model for encoding/decoding the motion feature.

### Main Coding Branch

The main coding branch is shown in FIGS. 19 and 20. FIG. 19 depicts the feature coding for the main branch, and FIG. 20 depicts the octree coding for the main branch.

### Feature-Based Coding

FIG. 19 is a process diagram illustrating an example main hierarchical feature coding branch using a predicted feature according to some embodiments. The encoder, which is shown in the top part of the figure, has a few CNN-like neural network blocks 1908, 1910, 1912. They extract and aggregate a feature map from the input, for example, point cloud frames. During feature extraction and aggregation, the resolution of the input is typically downsampled via downsampling operations that may include a downsampling block 1902, 1904, 1906 that outputs to a CNN block 1908, 1910, 1912.

Compared to FIG. 4, when the predicted feature F_{pred} is available, both the predicted feature F_{pred}, and the extracted feature F are inputted to the conditional encoder CE 1914 and then a feature encoder block 1916 for feature encoding.

On the decoder side, both the predicted feature F_{pred} and the output of the feature decoder 1918 (the decoded feature) are inputted to the conditional decoder CD 1920 for decoding. For the rest of the details, the main branch of the feature-based coding is the same as FIG. 4.

The decoder, which is shown in the bottom part of FIG. 19, has a few CNN-like neural network blocks 1922, 1924, 1926. They correspond to the few CNN-like neural network blocks 1908, 1910, 1912 in the encoder. Instead of performing downsampling/pooling, the CNN-like neural network blocks 1922, 1924, 1926 reconstruct the input (e.g., a point cloud) via upsampling/unpooling of the output of the conditional decoder 1920.

### Octree Coding

FIG. 20 is a process diagram illustrating an example main octree coding branch using predicted features according to some embodiments. Compared to FIG. 5, when the predicted feature F_{pred} is available, both F_{pred}, and the extracted feature F, may be inputted to the conditional encoders (CE) 2014, 2016, 2018 for feature encoding and to generate the feature F′ for occupancy encoding.

For the octree coding process 2000, a few CNNs 2008, 2010, 2012 in the top are used during encoding and they downsample the point cloud. The features extracted by the CNNs 2008, 2010, 2012 are encoded by conditional encoders (CE) 2014, 2016, 2018 and then feature encoders 2020, 2026, 2030 into bitstreams. The quantized feature output by the feature encoder FE 2020, 2026, 2030 are inputted to the conditional decoders (CD) 2052, 2054, 2056 for conditional decoding and reconstruct the feature F′. The feature F′ may be viewed as the reconstruction of F which contains the finer geometry information. The feature F′ are then inputted to the octree encoding blocks 2024, 2028, 2032 to assist the octree encoding. For some embodiments, a series of downsampling blocks 2002, 2004, 2006 may be used to generate inputs to the octree-encoding blocks 2024, 2028, 2032.

On the decoder side, both F_{pred}, and the decoded feature may be inputted to the conditional decoder CD 2040, 2042, 2044 for decoding F′ and the subsequent occupancy decoding. For the rest of the details, the main branch of the feature-based coding remains the same as FIG. 5. Additionally, on decoder side, the feature is decoded by FD blocks 2034, 2036, 2038. These decoded features F′ are the same as the features output by the CD blocks 2052, 2054, 2056 on the encoder side. These features are used to assist the octree decoding OD blocks 2046, 2048, 2050 to decode the occupancies.

### Motion Estimation and Predictor Generator

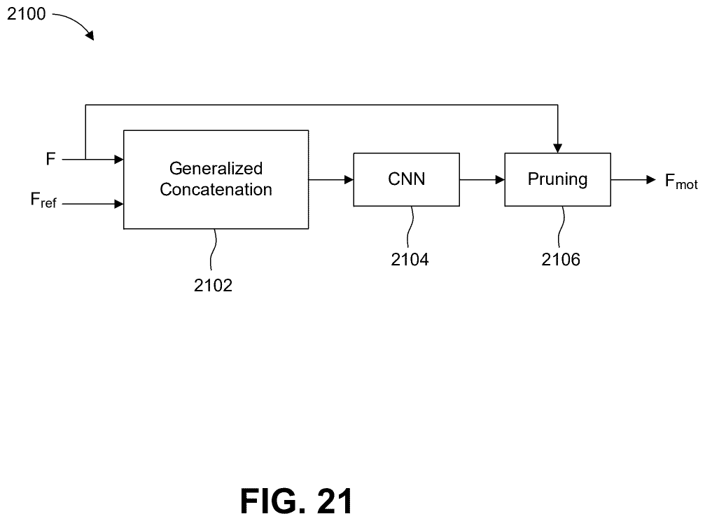

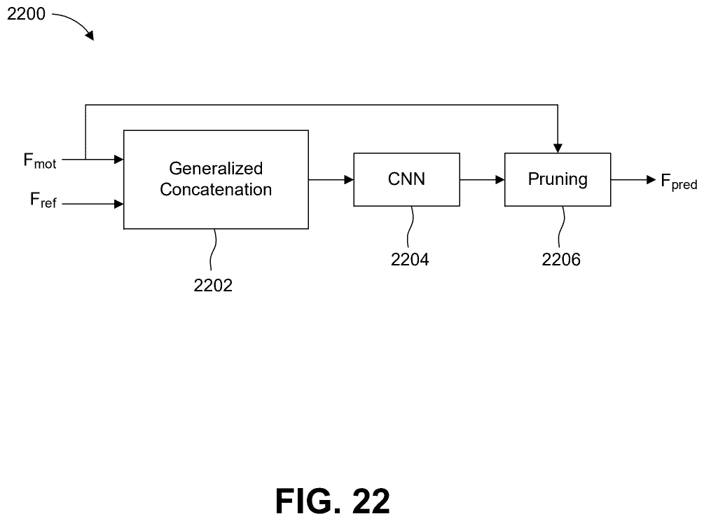

The diagrams of the motion estimation and the predictor generator are provided in FIGS. 21 and 22, respectively.

FIG. 21 is a process diagram illustrating an example motion estimator according to some embodiments. The motion estimation block 2100 takes the current feature F and the reference feature F_{ref} as inputs. These inputs are inputted into a generalized concatenation block 2102, which is capable of concatenating two sparse tensor with different coordinates. The generalized concatenation block outputs a tensor as described below. The concatenated feature map for a 3D coordinate u is defined as shown in Eq. 1:

$${F}_{out} ( u ) = \{ \begin{matrix}Concat ( F ( u ) , {F}_{ref} ( u ) ) & u ∈ {B}_{cur} ⋂ {B}_{ref} \\ Concat ( 0 , {F}_{ref} ( u ) ) & u ∉ {B}_{cur} and u ∈ {B}_{ref} \\ Concat ( F ( u ) , 0 ) & u ∈ {B}_{cur} and u ∉ {B}_{ref}\end{matrix} \qquad ( 1 )$$

B_{cur} and B_{ref} are the coordinates of the current point cloud and the reference point cloud, respectively. u∈B_{cur}∪B_{ref}, 0 is a vector with all zeros. The function “Concat( )” is a regular vector concatenation. F_{cur}(u) is the feature vector of Four defined at u, similarly for F_{ref} (u) and F_{cmb}(u). In this way, the coordinates of F_{cmb} becomes the union of B_{cur} and B_{ref}, which may be depicted as B_{cur}∪B_{ref}.

The output feature map of the generalized concatenation block 2102 is passed to a CNN block 2104 for feature aggregation, followed by a pruning block 2106 to remove coordinates that exist in F_{ref} but not in the current feature F. Finally, the pruning block 2106 outputs the motion feature Fₘₒₜ.

FIG. 22 is a process diagram illustrating an example predictor generator according to some embodiments. The predictor generator 2200 has a similar structure as the example motion estimator of FIG. 21. However, the inputs to the predictor generator 2200 are the motion feature Fₘₒₜ and the reference feature F_{ref}. The output is the predicted feature F_{pred}, which has a coordinate aligned with Fₘₒₜ.

The motion feature Fₘₒₜ and the reference feature F_{ref} are inputted to the generalized concatenation block 2202. The output of the generalized concatenation block 2202 is passed to a CNN block 2204 for feature aggregation, followed by a pruning block 2206 to remove coordinates that exist in Fₘₒₜ but not in the reference feature F_{ref}. Finally, the pruning block 2206 outputs the predicted feature F_{pred}.

### Parameter Sharing

In the design of FIGS. 17-20, the CNN blocks on the encoder side may have similar architectures, and the CNN blocks on the decoder side may also have similar architectures. Such similarity of network architecture motivates us to propose the following:
1) Let all the CNN blocks on the encoder side to share the same set of network parameters;
2) Let all the CNN blocks on the decoder side to share the same set of network parameters.

Without model sharing, the feature-based coding and octree-based coding will use two sets of separate neural networks parameters. This constraint not only makes the overall parameter size larger but also requires retraining and reloading of the neural network parameters when the bottleneck level separating feature-based coding and octree-based coding is changed.

For some embodiments, the feature-based (lossy) coding and octree-based (lossless) coding are additionally unified under the same set of encoder and decoder CNN pairs. During inference, the codec may be reconfigurable while maintaining the conformance/compatibility using the same set of neural network parameters.

### Intra Mode

Some embodiments may operate in the intra mode, where the reference point cloud is not available. In this case, the inter branch will not be launched and only the main branch will be kept for encoding/decoding. Additionally, the predicted feature is set to be a constant feature where all of its entries are predefined. For example, all of its entries may be set to 1 (during both training and inference).

### Hierarchical Bitstream for Feature-Based Coding

For some embodiments, the encoding of motion and feature bitstreams are extended to enable hierarchical feature-based coding in the inter branch, instead of single feature-based coding bitstreams like in FIGS. 17 and 18.

The '144 application mentions further unifying feature-based coding and octree-based coding. The same methodology may be used here to generate a motion bitstream for each octree level (or for the last few octree levels). Multiple motion bitstreams (one bitstream for one level) may be computed for the feature-based coding so that the inter correlation between the current point cloud and the reference point cloud may be fully utilized and benefit the coding performance.

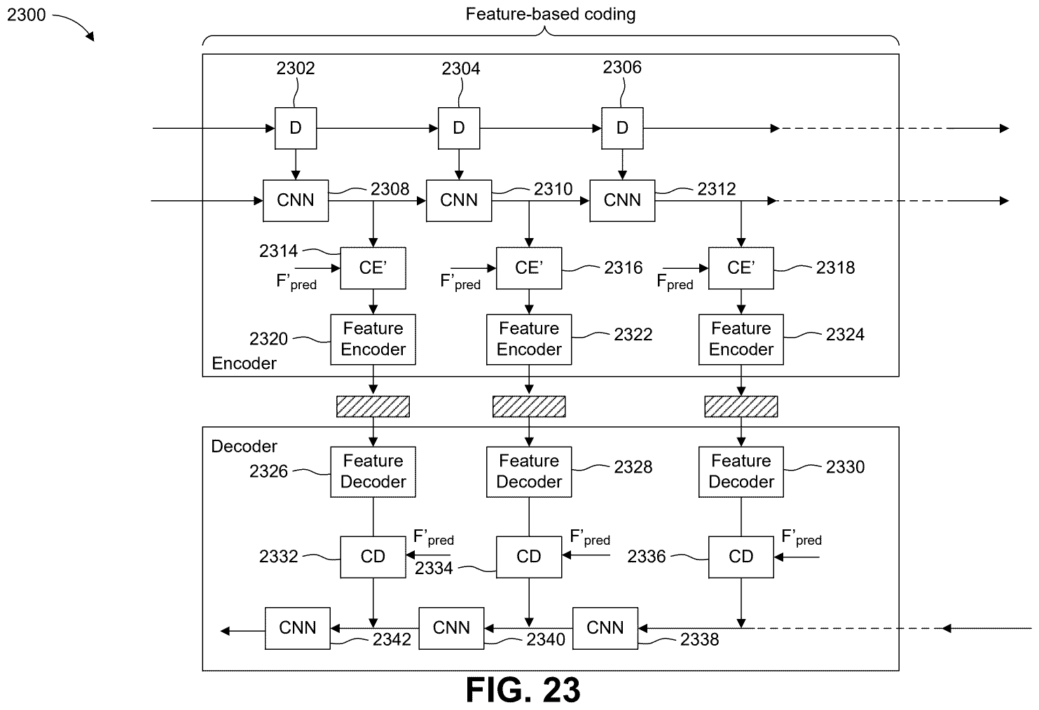

FIG. 23 is a process diagram illustrating an example main feature coding branch using predicted features according to some embodiments. The updated feature-based coding is depicted in FIG. 23, where the feature-based bitstream is encoded/decoded for each of the last few octree levels. Compared to FIG. 18, F′pred is used instead of F_{pred}, and CE′ 2314, 2316, 2318 is used instead to CE. F′pred may be obtained from the example predictor generator shown in FIG. 22, but F′ₘₒₜ may be used instead of Fₘₒₜ.

A feature-based encoding and decoding method 2300 is shown in FIG. 23. The encoder, which is shown in the top part of the figure, has a few CNN-like neural network blocks 2308, 2310, 2312. They extract and aggregate a feature map from the input, for example, point cloud frames. During feature extraction and aggregation, the resolution of the input is typically downsampled via downsampling operations that may include a downsampling block 2302, 2304, 2306 that outputs to a CNN block 2308, 2310, 2312. Finally, the extracted feature is sent to a feature encoder (FE) block 2320, 2322, 2324 to output a bitstream.

The decoder, which is shown in the bottom part of FIG. 23, has a few CNN-like neural network blocks 2338, 2340, 2342. They correspond to the few CNN-like neural network blocks 2308, 2310, 2312 in the encoder. Instead of performing downsampling/pooling, the CNN-like neural network blocks 2338, 2340, 2342 reconstruct the input (e.g., a point cloud) via upsampling/unpooling of the outputs of the linked sets of respective feature decoder 2326, 2328, 2330 to respective conditional decoder 2332, 2334, 2336.

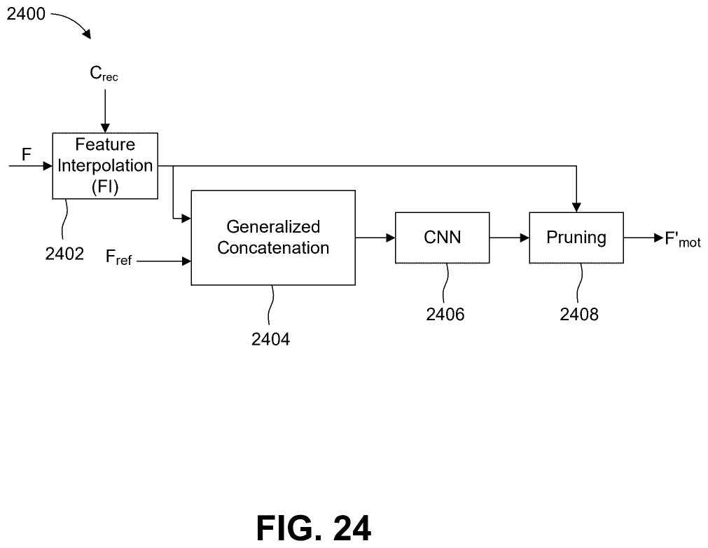

FIG. 24 is a process diagram illustrating an example lossy motion estimator according to some embodiments. F′ₘₒₜ may be obtained from the example lossy motion estimation process 2400 shown in FIG. 24. The example process 2400 uses a feature interpolation (FI) block 2402 to interpolate the features of the current level F to the lossy reconstructed coordinates from the previous level (C_{rec} in FIG. 24).

The reference feature F_{ref} and the output of the feature interpolation block 2402 are inputted into the generalized concatenation block 2404. The output feature map of the generalized concatenation block 2404 is passed to a CNN block 2406 for feature aggregation, followed by a pruning block 2408 to remove coordinates that exist in F_{ref} but not in the current feature F. Finally, the pruning block 2408 outputs the motion feature F′ₘₒₜ.

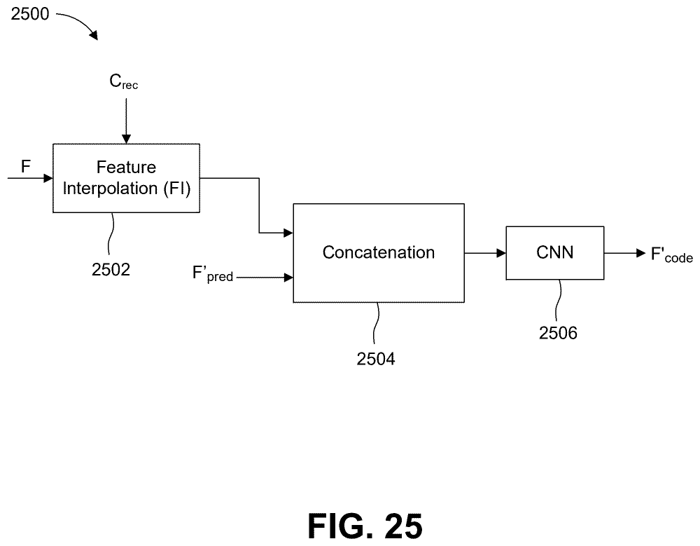

FIG. 25 is a process diagram illustrating an example lossy conditional encoder according to some embodiments. As seen in FIG. 25, the lossy conditional encoder uses a feature interpolation (FI) block 2502 to first interpolate the features of the current level F before any further processing. This FI block 2502 is used to ensure that the encoder and decoder do not have a mismatch and so that both the encoder and decoder operate based on the lossy reconstruction from the previous level.

For the FI block, any traditional or learning based feature interpolation approach may be employed. In some embodiments, a nearest neighbor-based approach may be used to match the lossy reconstructed points with its nearest neighbors from the coordinates of F, and then a weighted average based on distance may be used to interpolate the features to obtain a feature at each lossy reconstructed point. In some embodiments, the interpolation may be performed by first performing a learning-based feature aggregation followed by a target convolution, which interpolates input features to the specified target locations.

The predicted feature F′_{pred} and the output of the feature interpolation block 2502 are inputted into the concatenation block 2504. The output feature map of the concatenation block 2504 is passed to a CNN block 2506 for feature aggregation. Finally, the CNN block 2506 outputs the coded feature F′_{code}.

Motion Estimation with Multiple Resolutions

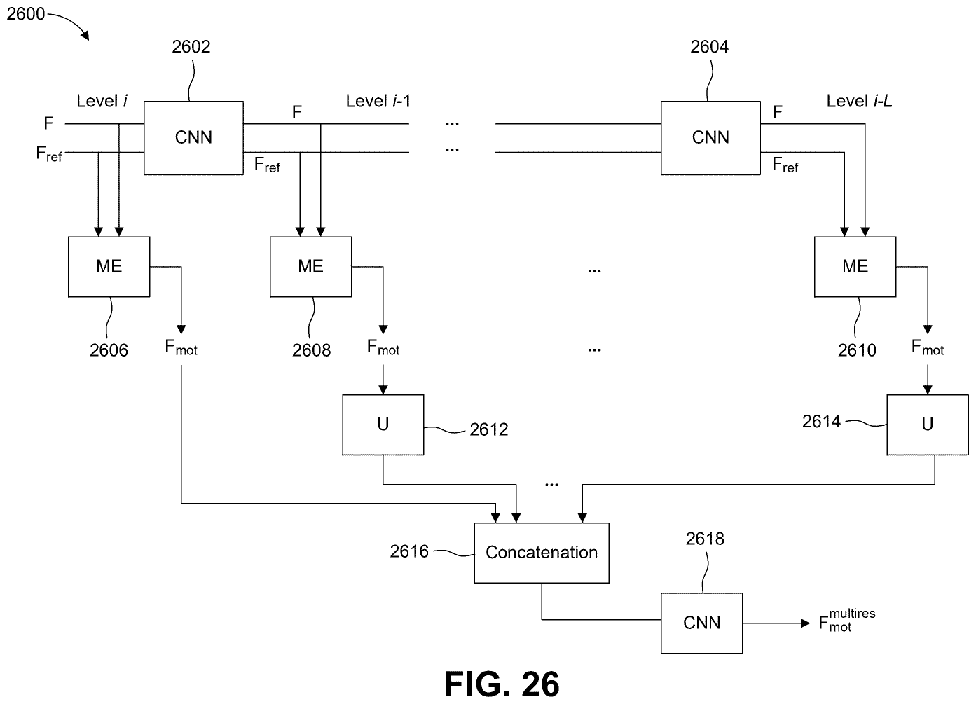

FIG. 26 is a process diagram illustrating an example motion estimator using multiple resolutions according to some embodiments. For some embodiments, the motion estimation block presented in FIG. 21 is extended to consider more ancestor level motions directly from a specific point cloud level. A so-called multi-resolution motion estimation block may combine L+1 levels of motions in one level motion feature. This enhanced architecture 2600 may be implemented by replacing each ME block illustrated in FIG. 17 with FIG. 26. This enhanced multi-resolution motion feature may be more efficient to code a motion feature with larger motion information available.

As illustrated in FIG. 26, the inputs and outputs of the ME blocks 2606, 2608, 2610 are identical to the ME block(s) illustrated in FIG. 17 and FIG. 21. Furthermore, the inputs and output of the whole multi-resolution motion estimation architecture 2600 of FIG. 26 are also identical to the ME block(s) illustrated in FIG. 17 and FIG. 21.

This multi-resolution motion estimation block 2600 takes the current feature F and the reference feature F_{ref} as inputs, then outputs a multi-resolution motion feature Fₘₒₜ^{multires}. The motion estimation (ME) blocks 2606, 2608, 2610 are additionally processed L-time for each ancestor level, from “Level i−1” to “Level i−L” and outputs motion features Fₘₒₜ of each level. A CNN block 2602, 2604 may separate each level.

Apart from the “Level i” ME, the other MEs are used to downsample current feature F and reference feature F_{ref} to the corresponding level from i−1 to i−L. Similar to that illustrated in FIG. 17, a CNN block extracts a downsampled feature is used. Then, after processing each motion estimation, the extracted motions may be upsampled to the initial level of motion by processing with the U blocks 2612, 2614 located from level i−1 to i−L. Here to upsample from level i−k to i, an U block consists of a series of k unpooling and pruning operators. After the U blocks, the motion features are all aligned at level i. These aligned motion features may be merged to one multi-resolution motion feature, Fₘₒₜ^{multires}. The merging process may be achieved by a series of one or more concatenation blocks 2616 and one or more CNN blocks 2618 in some embodiments.

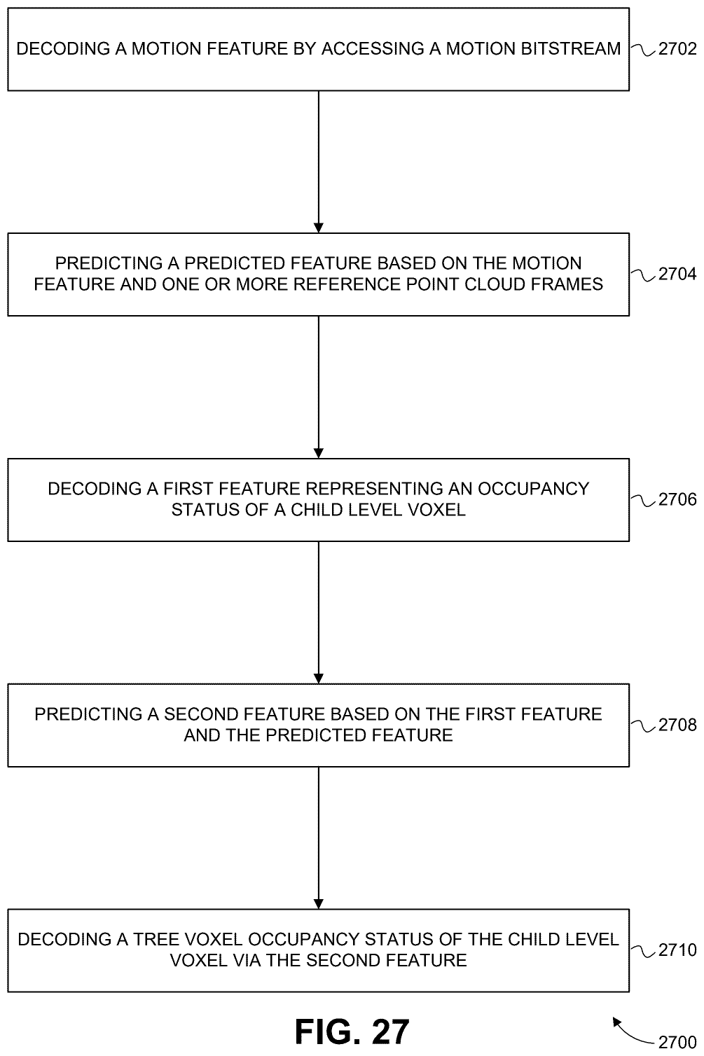

FIG. 27 is a flowchart illustrating an example decoding process according to some embodiments. For some embodiments, an example process 2700 may include decoding 2702 a motion feature by accessing a motion bitstream. For some embodiments, the example process 2700 may further include 2704 predicting a predicted feature based on the motion feature and one or more reference point cloud frames. For some embodiments, the example process 2700 may further include 2706 decoding a first feature representing an occupancy status of a child level voxel. For some embodiments, the example process 2700 may further include 2708 predicting a second feature based on the first feature and the predicted feature. For some embodiments, the example process 2700 may further include decoding 2710 a tree voxel occupancy status of the child level voxel via the second feature.

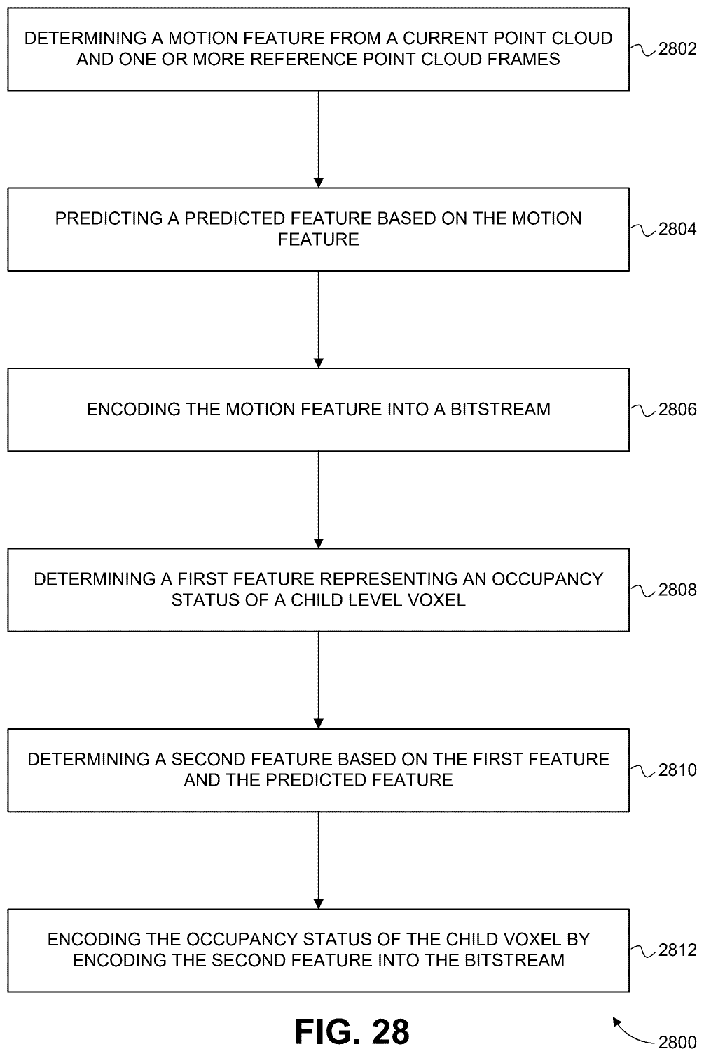

FIG. 28 is a flowchart illustrating an example encoding process according to some embodiments. For some embodiments, an example process 2800 may include determining 2802 a motion feature from a current point cloud and one or more reference point cloud frames. For some embodiments, the example process 2800 may further include predicting 2804 a predicted feature based on the motion feature. For some embodiments, the example process 2800 may further include encoding 2806 the motion feature into a bitstream. For some embodiments, the example process 2800 may further include determining 2808 a first feature representing an occupancy status of a child level voxel. For some embodiments, the example process 2800 may further include determining 2810 a second feature based on the first feature and the predicted feature. For some embodiments, the example process 2800 may further include encoding 2812 the occupancy status of the child level voxel by encoding the second feature into the bitstream.

An example apparatus in accordance with some embodiments may include at least one processor configured to perform any one of the methods described within this application. An example apparatus in accordance with some embodiments may include a computer-readable medium storing instructions for causing one or more processors to perform any one of the methods described within this application. An example apparatus in accordance with some embodiments may include at least one processor and at least one non-transitory computer-readable medium storing instructions for causing the at least one processor to perform any one of the methods described within this application. An example signal in accordance with some embodiments may include a bitstream generated according to any one of the methods described within this application.

For some embodiments, a tree voxel occupancy status may represent a portion of a current point cloud geometry. For some embodiments, a feature decoding process may use one or more estimated parameters.

While the methods and systems in accordance with some embodiments are generally discussed in context of extended reality (XR), some embodiments may be applied to any XR contexts such as, e.g., virtual reality (VR)/mixed reality (MR)/augmented reality (AR) contexts. Also, although the term “head mounted display (HMD)” is used herein in accordance with some embodiments, some embodiments may be applied to a wearable device (which may or may not be attached to the head) capable of, e.g., XR, VR, AR, and/or MR for some embodiments.

A first example method in accordance with some embodiments may include: decoding a motion feature by accessing a motion bitstream; predicting a predicted feature based on the motion feature and one or more reference point cloud frames; decoding a first feature representing an occupancy status of a child level voxel; predicting a second feature based on the first feature and the predicted feature; and decoding a tree voxel occupancy status of the child level voxel via the second feature.

For some embodiments of the first example method, decoding the motion feature includes: obtaining the motion bitstream; and passing the motion bitstream through a feature decoding process to obtain the motion feature.

For some embodiments of the first example method, the feature decoding process includes using an input derived from the one or more reference point cloud frames.

For some embodiments of the first example method, the input is derived from the one or more reference point cloud frames by performing a parameter estimation process on a reconstructed motion feature.

For some embodiments of the first example method, the reconstructed motion feature is derived from the one or more reference point cloud frames and the motion bitstream.

For some embodiments of the first example method, predicting the second feature includes passing the first feature and the predicted feature through a conditional decoder.

For some embodiments of the first example method, predicting the predicted feature includes: obtaining the one or more reference point cloud frames; and performing a predictor generation process based on the motion feature and the one or more reference point cloud frames to generate the predicted feature.

For some embodiments of the first example method, decoding the tree voxel occupancy status of the child level voxels includes: estimating occupancy probabilities using the second feature; accessing an occupancy bitstream; and performing arithmetic decoding of the occupancy bitstream via the estimated occupancy probabilities.

A first example apparatus in accordance with some embodiments may include: a processor; and a memory storing instructions operative, when executed by the processor, to cause the apparatus to: decode a motion feature by accessing a motion bitstream; predict a predicted feature based on the motion feature and one or more reference point cloud frames; decode a first feature representing an occupancy status of a child level voxel; predict a second feature based on the first feature and the predicted feature; and decode a tree voxel occupancy status of the child level voxel via the second feature.

A second example method in accordance with some embodiments may include: determining a motion feature from a current point cloud and one or more reference point cloud frames; predicting a predicted feature based on the motion feature; encoding the motion feature into a bitstream; determining a first feature representing an occupancy status of a child level voxel; determining a second feature based on the first feature and the predicted feature; and encoding the occupancy status of the child level voxel by encoding the second feature into the bitstream.

For some embodiments of the second example method, determining the motion feature includes: extracting a current feature from the current point cloud; and performing a motion estimation process on the extracted current feature and at least one of the one or more reference point cloud frames.

For some embodiments of the second example method, encoding the occupancy status of the child voxels includes: determining a third feature based on the second feature and the predicted feature; determining occupancy probabilities of the child voxels to be encoded; and encoding the occupancy status of the child voxels with the occupancy probabilities in an occupancy bitstream using an arithmetic encoder.

For some embodiments of the second example method, encoding the motion feature into the bitstream includes performing a feature encoding process on the motion feature using one or more estimated parameters.

For some embodiments of the second example method, the one or more estimated parameters includes at least one of a mean and a variance of previous reconstructed motion features.

For some embodiments of the second example method, predicting the predicted feature includes using a hyperprior encoder.

For some embodiments of the second example method, predicting the predicted feature includes: obtaining the motion feature from the bitstream; and passing the motion feature through a feature decoding process to obtain a first reconstructed motion feature.

For some embodiments of the second example method, the feature decoding process includes using an input derived from the one or more reference point cloud frames.

For some embodiments of the second example method, the input is derived from the one or more reference point cloud frames by performing a parameter estimation process on a second reconstructed motion feature.

For some embodiments of the second example method, at least one of the first reconstructed motion feature and the second reconstructed motion feature is derived based on the one or more reference point cloud frames.

A second example apparatus in accordance with some embodiments may include: a processor; and a memory storing instructions operative, when executed by the processor, to cause the apparatus to: determine a motion feature from a current point cloud and one or more reference point cloud frames; predict a predicted feature based on the motion feature; encode the motion feature into a bitstream; determine a first feature representing an occupancy status of a child level voxel; determine a second feature based on the first feature and the predicted feature; and encoding the occupancy status of the child level voxel by encoding the second feature into the bitstream.

One or more embodiments provide a computer program comprising instructions which when executed by one or more processors cause such processors to perform the encoding and/or decoding methods according to any of the embodiments described above. One or more embodiments also provide a computer readable storage medium having stored thereon instructions for encoding or decoding video data according to the methods described above.

One or more embodiments provide a computer readable storage medium having stored thereon video data generated according to the methods described above. One or more embodiments also provide a method and apparatus for transmitting or receiving video data generated according to the methods described above.

The embodiments described herein may be implemented in, for example, a method or a process, an apparatus, a software program, a data stream, or a signal. Even if only discussed in the context of a single form of implementation (e.g., as a method), the implementation of such features may also be implemented in other forms. An apparatus may be implemented in, for example, appropriate hardware, software, and firmware. Corresponding methods may be implemented in, for example, a processor.

Various numeric values are used in the present application. Such specific values are for example purposes and the embodiments described are not limited to these specific values.

Various methods are described herein, and such methods comprise one or more steps or actions for achieving the described method. Unless a specific order of steps or actions is required for the proper operation of the method, the order and/or use of specific steps and/or actions may be modified or combined. Additionally, terms such as “first”, “second”, etc. may be used in various embodiments to modify an element, component, step, operation, etc., for example, a “first decoding” and a “second decoding”. Use of such terms does not imply an order to the operations unless specifically required.

The present disclosure may refer to “determining” various pieces of information. Determining information may include one or more of, for example, estimating, calculating, predicting, or retrieving (e.g., from memory) the information.

The present disclosure may refer to “accessing” various pieces of information. Accessing information may include one or more of, for example, receiving, retrieving (e.g., from memory), storing, moving, copying, calculating, determining, predicting, or estimating the information. Similarly, the present disclosure may refer to “receiving” various pieces of information. Receiving information may include one or more of, for example, accessing or retrieving (e.g., from memory) the information.

It is to be understood that use of any of the following “/”, “and/or”, and “at least one of” is intended to encompass all possible selections of listed items, taken either individually or in any combination thereof.

While specific embodiments have been described in the foregoing description in connection with the accompanying drawings, it should be understood that embodiments described herein are examples only and should not be taken as limiting the scope of the present disclosure or the following claims. Although features and elements are described herein in particular combinations, those of ordinary skill in the art will appreciate that such features or elements may be used alone or in any combination with the other features and elements. It is understood, therefore, that the overall teachings of the present disclosure are not limited to the particular embodiments, implementations, and examples disclosed herein, but are intended to cover variations, modifications, and alternatives as defined by the appended claims and any and all equivalents thereof.

This disclosure describes a variety of aspects, including tools, features, embodiments, models, approaches, etc. Many of these aspects are described with specificity and, at least to show the individual characteristics, are often described in a manner that may sound limiting. However, this is for purposes of clarity in description, and does not limit the disclosure or scope of those aspects. Indeed, all of the different aspects can be combined and interchanged to provide further aspects. Moreover, the aspects can be combined and interchanged with aspects described in earlier filings as well.

Various numeric values may be used in the present disclosure, for example. The specific values are for example purposes and the aspects described are not limited to these specific values.

Embodiments described herein may be carried out by computer software implemented by a processor or other hardware, or by a combination of hardware and software. As a non-limiting example, the embodiments can be implemented by one or more integrated circuits. The processor can be of any type appropriate to the technical environment and can encompass one or more of microprocessors, general purpose computers, special purpose computers, and processors based on a multi-core architecture, as non-limiting examples.

When a figure is presented as a flow diagram, it should be understood that it also provides a block diagram of a corresponding apparatus. Similarly, when a figure is presented as a block diagram, it should be understood that it also provides a flow diagram of a corresponding method/process.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this disclosure are not necessarily all referring to the same embodiment.

Additionally, this disclosure may refer to “determining” various pieces of information. Determining the information can include one or more of, for example, estimating the information, calculating the information, predicting the information, or retrieving the information from memory.

Further, this disclosure may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this disclosure may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items as are listed.

Implementations can produce a variety of signals formatted to carry information that can be, for example, stored or transmitted. The information can include, for example, instructions for performing a method, or data produced by one of the described implementations. For example, a signal can be formatted to carry the bitstream of a described embodiment. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on a processor-readable medium.

Note that various hardware elements of one or more of the described embodiments are referred to as “modules” that carry out (i.e., perform, execute, and the like) various functions that are described herein in connection with the respective modules. As used herein, a module includes hardware (e.g., one or more processors, one or more microprocessors, one or more microcontrollers, one or more microchips, one or more application-specific integrated circuits (ASICs), one or more field programmable gate arrays (FPGAs), one or more memory devices) deemed suitable by those of skill in the relevant art for a given implementation. Each described module may also include instructions executable for carrying out the one or more functions described as being carried out by the respective module, and it is noted that those instructions could take the form of or include hardware (i.e., hardwired) instructions, firmware instructions, software instructions, and/or the like, and may be stored in any suitable non-transitory computer-readable medium or media, such as commonly referred to as RAM, ROM, etc.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method comprising:
decoding a motion feature by accessing a motion bitstream;
predicting a predicted feature based on the motion feature and one or more reference point cloud frames;
decoding a first feature representing an occupancy status of a child level voxel;
predicting a second feature based on the first feature and the predicted feature; and
decoding a tree voxel occupancy status of the child level voxel via the second feature.

2. The method of claim 1, wherein decoding the motion feature comprises:
obtaining the motion bitstream; and
passing the motion bitstream through a feature decoding process to obtain the motion feature.

3. The method of claim 2, wherein the feature decoding process comprises using an input derived from the one or more reference point cloud frames.

4. The method of claim 3, wherein the input is derived from the one or more reference point cloud frames by performing a parameter estimation process on a reconstructed motion feature.

5. The method of claim 4, wherein the reconstructed motion feature is derived from the one or more reference point cloud frames and the motion bitstream.

6. The method of claim 1, wherein predicting the second feature comprises passing the first feature and the predicted feature through a conditional decoder.

7. The method of claim 1, wherein predicting the predicted feature comprises:
obtaining the one or more reference point cloud frames; and
performing a predictor generation process based on the motion feature and the one or more reference point cloud frames to generate the predicted feature.

8. The method of claim 1, wherein decoding the tree voxel occupancy status of the child level voxels comprises:
estimating occupancy probabilities using the second feature;
accessing an occupancy bitstream; and
performing arithmetic decoding of the occupancy bitstream via the estimated occupancy probabilities.

9. An apparatus comprising:
a processor; and
a memory storing instructions operative, when executed by the processor, to cause the apparatus to:
decode a motion feature by accessing a motion bitstream;
predict a predicted feature based on the motion feature and one or more reference point cloud frames;
decode a first feature representing an occupancy status of a child level voxel;
predict a second feature based on the first feature and the predicted feature; and
decode a tree voxel occupancy status of the child level voxel via the second feature.

10. A method comprising:
determining a motion feature from a current point cloud and one or more reference point cloud frames;
predicting a predicted feature based on the motion feature;
encoding the motion feature into a bitstream;
determining a first feature representing an occupancy status of a child level voxel;
determining a second feature based on the first feature and the predicted feature; and
encoding the occupancy status of the child level voxel by encoding the second feature into the bitstream.

11. The method of claim 10, wherein determining the motion feature comprises:
extracting a current feature from the current point cloud; and
performing a motion estimation process on the extracted current feature and at least one of the one or more reference point cloud frames.

12. The method of claim 10, wherein encoding the occupancy status of the child voxels comprises:
determining a third feature based on the second feature and the predicted feature;
determining occupancy probabilities of the child voxels to be encoded; and
encoding the occupancy status of the child voxels with the occupancy probabilities in an occupancy bitstream using an arithmetic encoder.

13. The method of claim 10, wherein encoding the motion feature into the bitstream comprises performing a feature encoding process on the motion feature using one or more estimated parameters.

14. The method of claim 13, wherein the one or more estimated parameters comprises at least one of a mean and a variance of previous reconstructed motion features.

15. The method of claim 10, wherein predicting the predicted feature comprises using a hyperprior encoder.

16. The method of claim 10, wherein predicting the predicted feature comprises:
obtaining the motion feature from the bitstream; and
passing the motion feature through a feature decoding process to obtain a first reconstructed motion feature.

17. The method of claim 15, wherein the feature decoding process comprises using an input derived from the one or more reference point cloud frames.

18. The method of claim 17, wherein the input is derived from the one or more reference point cloud frames by performing a parameter estimation process on a second reconstructed motion feature.

19. The method of claim 18, wherein at least one of the first reconstructed motion feature and the second reconstructed motion feature is derived based on the one or more reference point cloud frames.

20. An apparatus comprising:
a processor; and
a memory storing instructions operative, when executed by the processor, to cause the apparatus to:
determine a motion feature from a current point cloud and one or more reference point cloud frames;
predict a predicted feature based on the motion feature;
encode the motion feature into a bitstream;
determine a first feature representing an occupancy status of a child level voxel;
determine a second feature based on the first feature and the predicted feature; and
encoding the occupancy status of the child level voxel by encoding the second feature into the bitstream.
